(19) United States
(12) Patent Application Publication
(10) Pub. No.: US 2026/0081361 A1
(43) Pub. Date: Mar. 19, 2026

(54) ELECTROMAGNETIC WAVE ABSORBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: TAKUYA NAKAMURA, Nisshin-shi (JP)

(21) Appl. No.: 19/255,262

(22) Filed: Jun. 30, 2025

(30) Foreign Application Priority Data
Sep. 13, 2024 (JP) 2024-159216

(51) Int. Cl. H01Q 17/00; H01Q 15/14

(52) U.S. Cl. CPC H01Q 17/00; H01Q 15/14

(57) ABSTRACT

An electromagnetic wave absorber includes: a first member to transmit an electromagnetic wave incident from one side in a predetermined direction; a dielectric disposed on the other side of the first member in the predetermined direction; and a second member disposed on the other side of the dielectric in the predetermined direction. The second member has an inclined surface to retroreflect the electromagnetic wave transmitted through the dielectric. A normal direction of the inclined surface is inclined with respect to the predetermined direction. The dielectric attenuates the electromagnetic wave in a state where the electromagnetic wave is multi-reflected to resonate between the inclined surface and the first member.

### CROSS REFERENCE TO RELATED APPLICATION

This application is based on Japanese Patent Application No. 2024-159216 filed on Sep. 13, 2024, the disclosure of which is incorporated herein by reference.

### TECHNICAL FIELD

The present disclosure relates to an electromagnetic wave absorber.

### BACKGROUND

An electromagnetic wave absorber such as quarter-lambda(λ) wave absorber includes: a first member, as a semi-reflector, to transmit a part of incident electromagnetic waves incident from one side in a predetermined direction; and a second member arranged on the other side of the first member in the predetermined direction.

### SUMMARY

An electromagnetic wave absorber includes: a first member to transmit an electromagnetic wave incident from one side in a predetermined direction; a dielectric disposed on the other side of the first member in the predetermined direction; and a second member disposed on the other side of the dielectric in the predetermined direction. The second member has an inclined surface to retroreflect the electromagnetic wave transmitted through the dielectric. A normal direction of the inclined surface is inclined with respect to the predetermined direction. The dielectric may be configured to attenuate the electromagnetic wave in a state where the electromagnetic wave is multi-reflected to resonate between the inclined surface and the first member.

### BRIEF DESCRIPTION OF DRAWINGS

FIG. 1 is a perspective view of an electromagnetic wave absorber according to a first embodiment, illustrating openings formed in a first metal layer, triangular prisms formed on a second metal layer, and a dielectric disposed between the first metal layer and the second metal layer.

FIG. 2 is a perspective view of the electromagnetic wave absorber of the first embodiment, explaining a positional relationship between the openings and the triangular prisms.

FIG. 3 is a diagram showing a part of the electromagnetic wave absorber of the first embodiment, explaining a shape of a side surface of a triangular prism formed in the second metal layer and two angles of the side surface.

FIG. 4 is a schematic diagram showing a specific example of multiple reflections between the first metal layer and the second metal layer, of an electromagnetic wave incident through an opening from one side in a stacking direction in the electromagnetic wave absorber of the first embodiment.

FIG. 5 is a schematic diagram showing a positional relationship among a wavefront of an incident electromagnetic wave outside a dielectric, a wavefront of an incident electromagnetic wave inside the dielectric, and a wavefront of a reflected electromagnetic wave in an electromagnetic wave absorber of a comparative example relative to the first embodiment.

FIG. 6 is a schematic diagram showing a specific example of multiple reflections between a first metal layer and a second metal layer in the comparative example, of an electromagnetic wave incident through an opening.

FIG. 7 is a schematic diagram showing a positional relationship among a wavefront of an incident electromagnetic wave outside a dielectric, a wavefront of an incident electromagnetic wave inside the dielectric, and a wavefront of a reflected electromagnetic wave when an incident angle changes in the electromagnetic wave absorber of the first embodiment.

FIG. 8 is a schematic diagram showing a specific example of multiple reflections between a first metal layer and a second metal layer, of an electromagnetic wave in the comparative example before the incident angle changes.

FIG. 9 is a schematic diagram showing a specific example of multiple reflections between a first metal layer and a second metal layer, of an electromagnetic wave in the comparative example after the incident angle is changed.

FIG. 10 is a schematic diagram showing a specific example in which an incident electromagnetic wave is retroreflected by inclined surfaces of the second metal layer when the incident angle is 0° in the electromagnetic wave absorber of the first embodiment.

FIG. 11 is a schematic diagram showing a specific example in which an incident electromagnetic wave is retroreflected by an effective reflecting surface formed by the inclined surfaces of the second metal layer when the incident angle is 0° in the electromagnetic wave absorber of the first embodiment.

FIG. 12 is a schematic diagram showing a specific example in which an incident electromagnetic wave is retroreflected by inclined surfaces of the second metal layer when the incident angle is 5° in the electromagnetic wave absorber of the first embodiment.

FIG. 13 is a schematic diagram showing a specific example in which an incident electromagnetic wave is retroreflected by an effective reflecting surface formed by the inclined surfaces of the second metal layer when the incident angle is 5° in the electromagnetic wave absorber of the first embodiment.

FIG. 14 is a schematic diagram showing a specific example in which an incident electromagnetic wave is multi-reflected between the first metal layer and the inclined surfaces of the second metal layer when the incident angle is 0° in the electromagnetic wave absorber of the first embodiment.

FIG. 15 is a schematic diagram showing a specific example in which an electromagnetic wave is multi-reflected between the first metal layer and the inclined surfaces of the second metal layer when the incident angle is 5° in the electromagnetic wave absorber of the first embodiment.

FIG. 16 is a schematic diagram showing a wavefront of an incident electromagnetic wave and a wavefront of a reflected electromagnetic wave when the electromagnetic wave is multi-reflected between the first metal layer and the inclined surfaces of the second metal layer when the incident angle is 5° in the electromagnetic wave absorber of the first embodiment.

FIG. 17 is a schematic diagram showing a specific example of an effective reflecting surface formed by two pairs of adjacent inclined surfaces of the second metal layer of the electromagnetic wave absorber of the first embodiment.

FIG. 18 is a schematic diagram showing a wavefront of an incident electromagnetic wave and a wavefront of a reflected electromagnetic wave when the electromagnetic wave is multi-reflected between the first metal layer and the inclined surfaces of the second metal layer when the incident angle is 10° in the electromagnetic wave absorber of the first embodiment.

FIG. 19 is a diagram showing a relationship between a reflection loss and a resonant frequency of an electromagnetic wave when the incident angle of the electromagnetic wave is 0°, 20°, 40°, and 60° in the comparative example.

FIG. 20 is a diagram showing a relationship between a reflection loss and a resonant frequency of an electromagnetic wave when the incident angle of the electromagnetic wave is 0°, 20°, 40°, and 60° in the electromagnetic wave absorber of the first embodiment.

FIG. 21 is a diagram showing a relationship between a reflection loss and an incident angle of an electromagnetic wave when a frequency of the electromagnetic wave is 75.5 GHz, 76.0 GHz, 76.5 GHz, and 77.0 GHz in the comparative example.

FIG. 22 is a diagram showing a relationship between a reflection loss and an incident angle of an electromagnetic wave when a frequency of the electromagnetic wave is 75.5 GHz, 76.0 GHz, 76.5 GHz, and 77.0 GHz in the electromagnetic wave absorber of the first embodiment.

FIG. 23 is a diagram showing a relationship between an absorption frequency and a height of a triangular prism represented by λ as a unit when the incident angle is 0° and 40° when no bottom surface is provided between two triangular prisms in the electromagnetic wave absorber of the first embodiment.

FIG. 24 is a diagram for explaining multiple triangular prisms with a height of 0.15λ, in which λ represents a wavelength of electromagnetic wave traveling within the dielectric, when no bottom surface is provided between two triangular prisms in the electromagnetic wave absorber of the first embodiment.

FIG. 25 is a diagram for explaining multiple triangular prisms with a height of 0.55λ when no bottom surface is provided between two triangular prisms in the electromagnetic wave absorber of the first embodiment.

FIG. 26 is a diagram showing a relationship between an absorption frequency and a height of a triangular prism represented by λ as a unit when the incident angle is 0° and 40° when a bottom surface is provided between two triangular prisms in the electromagnetic wave absorber of the first embodiment.

FIG. 27 is a diagram for explaining multiple triangular prisms with a height of 0.15λ, in which λ represents a wavelength of electromagnetic wave traveling within the dielectric, when a bottom surface is provided between two triangular prisms in the electromagnetic wave absorber of the first embodiment.

FIG. 28 is a diagram for explaining multiple triangular prisms with a height of 0.5λ, in which λ represents a wavelength of electromagnetic wave traveling within the dielectric, when a bottom surface is provided between two triangular prisms in the electromagnetic wave absorber of the first embodiment.

FIG. 29 is a side view of an electromagnetic wave absorber according to a second embodiment, illustrating a positional relationship between openings formed in a first metal layer and triangular prisms formed on a second metal layer.

FIG. 30 is a perspective view of an electromagnetic wave absorber according to a third embodiment, illustrating an opening formed in a first metal layer and inclined surfaces of a rectangular prism formed on a second metal layer.

FIG. 31 is a perspective view of an electromagnetic wave absorber according to a fourth embodiment, illustrating an opening formed in a first metal layer and inclined surfaces of a rectangular prism formed on a second metal layer.

FIG. 32 is a perspective view of the electromagnetic wave absorber of the fourth embodiment, illustrating the opening and inclined surfaces of three triangular prisms formed on the second metal layer.

FIG. 33 is a front view of the electromagnetic wave absorber of the fourth embodiment, illustrating two inclined surfaces of the triangular prism and another two inclined surfaces located on a side of the triangular prism when the first metal layer is removed.

FIG. 34 is a perspective view of the electromagnetic wave absorber of the fourth embodiment, illustrating the two inclined surfaces of one triangular prism and another two triangular prisms located on the side when the first metal layer is removed.

FIG. 35 is a perspective view of an electromagnetic wave absorber according to a fifth embodiment, illustrating an opening formed in a first metal layer, two inclined surfaces of a rectangular prism formed on a second metal layer, and two rectangular prisms located on a side of the rectangular prism.

FIG. 36 is a front view of the electromagnetic wave absorber of the fifth embodiment, illustrating the opening and the two inclined surfaces of the rectangular prism formed on the second metal layer.

FIG. 37 is a side view of the electromagnetic wave absorber of the fifth embodiment, illustrating the inclined surface of the rectangular prism and the two inclined surfaces located on a side of the rectangular prism.

FIG. 38 is a perspective view of the electromagnetic wave absorber of the fifth embodiment, illustrating the inclined surface of the rectangular prism and the two rectangular prisms located on a side of the rectangular prism.

FIG. 39 is a perspective view of an electromagnetic wave absorber according to a sixth embodiment, illustrating two curved reflecting surfaces formed on a triangular prism of a second metal layer.

FIG. 40 is a view of the electromagnetic wave absorber of the sixth embodiment, illustrating the two curved reflecting surfaces.

FIG. 41 is a side view of an electromagnetic wave absorber according to a seventh embodiment, for explaining two curved reflecting surfaces formed on a triangular prism of a second metal layer.

FIG. 42 is a perspective view of the electromagnetic wave absorber of the seventh embodiment, illustrating the two curved reflecting surfaces.

FIG. 43 is a front view of the electromagnetic wave absorber of the seventh embodiment, illustrating inclined surfaces of plural recesses formed in the second metal layer.

FIG. 44 is a side view of the electromagnetic wave absorber of the seventh embodiment, illustrating the inclined surfaces to form the plural recesses in the second metal layer.

FIG. 45 is a front view of the second metal layer of the electromagnetic wave absorber of the seventh embodiment, for explaining the inclined surfaces to form the plural recesses in the second metal layer, when the first metal layer is removed.

FIG. 46 is a schematic diagram showing three inclined surfaces of a single triangular pyramidal recess formed in the second metal layer of the electromagnetic wave absorber of the seventh embodiment, in which the opening is formed to face diagonally upward.

### DETAILED DESCRIPTION

Conventionally, several basic configurations are known as an electromagnetic wave absorber. An electromagnetic wave absorber known as a quarter-lambda(λ) type radio wave absorber includes: a first member as a semi-reflector that transmits a portion of incident electromagnetic waves incident from one side in a predetermined direction; and a second member arranged on the other side of the first member in the predetermined direction. The wavelength of the electromagnetic wave is represented by λ. An intermediate material serving as a dielectric is disposed between the first member and the second member. The second member reflects the electromagnetic waves that have passed through the intermediate material. In the electromagnetic wave absorber, when the electromagnetic wave is multi-reflected between the second member and the first member, the electromagnetic wave is attenuated by the resistance component of the first member, the dielectric loss due to the intermediate material, and the magnetic loss due to the intermediate material.

The present inventor investigates the use of the electromagnetic wave absorber to attenuate unwanted electromagnetic waves, which are emitted from an on-vehicle radar device to interfere with electromagnetic waves used to search the periphery of the vehicle. The on-vehicle radar device searches the surroundings of the vehicle using the electromagnetic waves having frequencies within a predetermined frequency range. For example, unwanted electromagnetic wave having a frequency within a predetermined frequency range may be incident on the electromagnetic wave absorber as incident electromagnetic wave. In this case, if the electromagnetic waves resonate at a frequency within the predetermined frequency range, the unwanted electromagnetic waves can be efficiently attenuated by the resistance component of the first member, the dielectric loss due to the intermediate material, and the magnetic loss due to the intermediate material.

An incident electromagnetic wave that has passed through a first member is reflected by a second member, and this reflected electromagnetic wave is reflected by the first member. At this time, if the wavefront of this reflected electromagnetic wave coincides with the wavefront of the incident electromagnetic wave that has passed through the first member, the electromagnetic wave can be resonated in the electromagnetic wave absorber.

In this case, the resonant frequency of the electromagnetic wave is determined by the positional relationship between the wavefront of the reflected electromagnetic wave reflected by the first member and the wavefront of the incident electromagnetic wave transmitted through the first member. Therefore, when the incident angle of the incident electromagnetic wave changes with respect to the electromagnetic wave absorber, the positional relationship between the wavefront of the reflected electromagnetic wave and the wavefront of the incident electromagnetic wave transmitted through the first member changes.

Therefore, when the incident angle of the incident electromagnetic wave changes, the resonant frequency changes and the resonant frequency may deviate from the predetermined frequency range. In this case, it is difficult to efficiently attenuate the unwanted electromagnetic waves having frequencies within the above-mentioned predetermined frequency range.

The present disclosure provides an electromagnetic wave absorber to suppress changes in resonant frequency when the incident angle of the electromagnetic wave changes.

An electromagnetic wave absorber includes: a first member to transmit an electromagnetic wave incident from one side in a predetermined direction; a dielectric disposed on the other side of the first member in the predetermined direction; and a second member disposed on the other side of the dielectric in the predetermined direction. The second member has an inclined surface to retroreflect the electromagnetic wave transmitted through the dielectric. A normal direction of the inclined surface is inclined with respect to the predetermined direction. The dielectric attenuates the electromagnetic wave in a state where the electromagnetic wave is multi-reflected to resonate between the inclined surface and the first member.

Therefore, the second member retroreflects the electromagnetic wave at the inclined surface. When the incident angle of the electromagnetic wave changes, it is possible to suppress a change in the positional relationship between the electromagnetic wave that has passed through the first member and the multiple-reflected electromagnetic wave. Thus, it is possible to suppress a change in the positional relationship between the wavefront of the electromagnetic wave that has passed through the first member and the wavefront of the multiple-reflected electromagnetic wave. Accordingly, it is possible to provide an electromagnetic wave absorber to suppress changes in resonant frequency when the incident angle of the electromagnetic wave changes.

Hereinafter, embodiments of the present disclosure will be described with reference to the drawings. In the following embodiments, the same or equivalent parts are denoted by the same reference numerals in the drawings to simplify the description.

### First Embodiment

An electromagnetic wave absorber 1 according to a first embodiment will be described with reference to the drawings. The electromagnetic wave absorber 1 of this embodiment attenuates unwanted electromagnetic waves that interfere with electromagnetic waves used to probe the surroundings of the vehicle, among the electromagnetic waves emitted from a radar device on the vehicle.

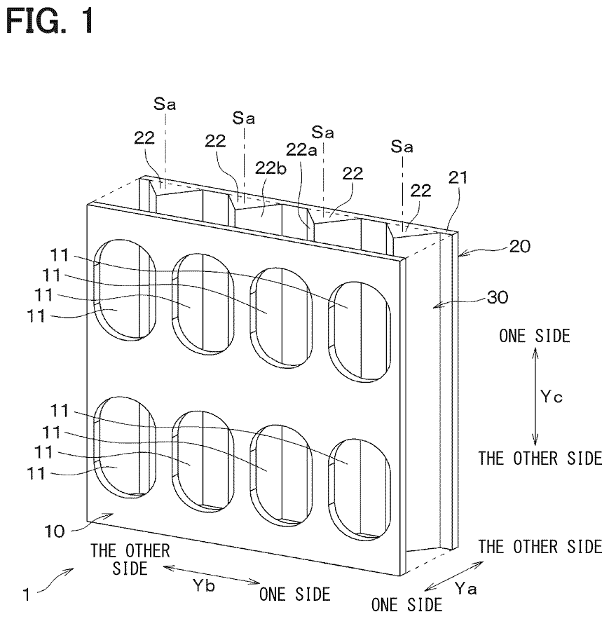

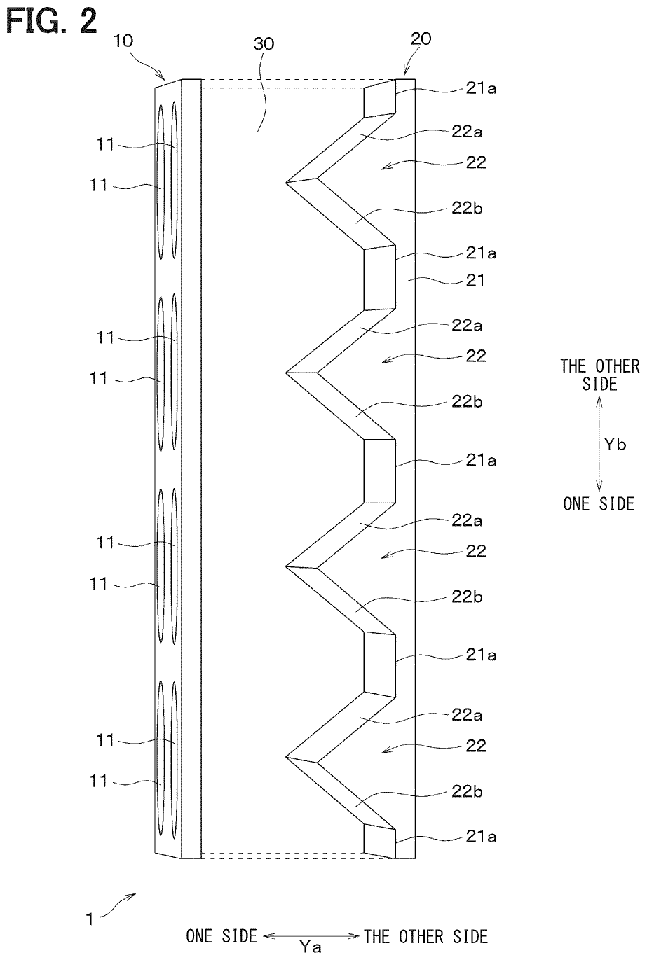

FIG. 1 is a perspective view showing the overall configuration of the electromagnetic wave absorber 1. FIG. 2 is another perspective view of the electromagnetic wave absorber 1. As shown in FIGS. 1 and 2, the electromagnetic wave absorber 1 includes a first metal layer 10, a second metal layer 20, and a dielectric 30 stacked in a stacking direction Ya. The first metal layer 10 is a first member formed in a thin film having a thickness direction corresponding to the stacking direction (i.e., a predetermined direction) Ya and extended along a lateral direction Yb and a vertical direction Yc. The lateral direction Yb is a second direction perpendicular to the stacking direction Ya. The vertical direction Yc is perpendicular to the lateral direction Yb and the stacking direction Ya.

The first metal layer 10 is made of a conductive metal material such as copper or silver. The first metal layer 10 has openings 11 formed therein. Each of the openings 11 is formed, for example, in an elliptical shape. The openings 11 are arranged in the vertical direction Yc and the lateral direction Yb. As a result, the first metal layer 10 has an aperture pattern having the openings 11 arranged in the vertical direction Yc and the lateral direction Yb. FIG. 1 shows, for example, eight openings 11 provided in the first metal layer 10.

As shown in FIGS. 1 and 2, the second metal layer 20 is a second member disposed on the other side of the first metal layer 10 in the stacking direction Ya. The second metal layer 20 is made of a conductive metal material such as copper or silver. The second metal layer 20 includes a base layer 21 and triangular prisms 22. The base layer 21 is formed in a thin film having a thickness direction corresponding to the stacking direction Ya and extended along the lateral direction Yb and the vertical direction Yc. Each of the triangular prisms 22 is a reflector disposed between the base layer 21 and the first metal layer 10. As shown in FIG. 1, each of the triangular prisms 22 is formed in a triangular prism shape and has an axis Sa extending in the vertical direction Yc.

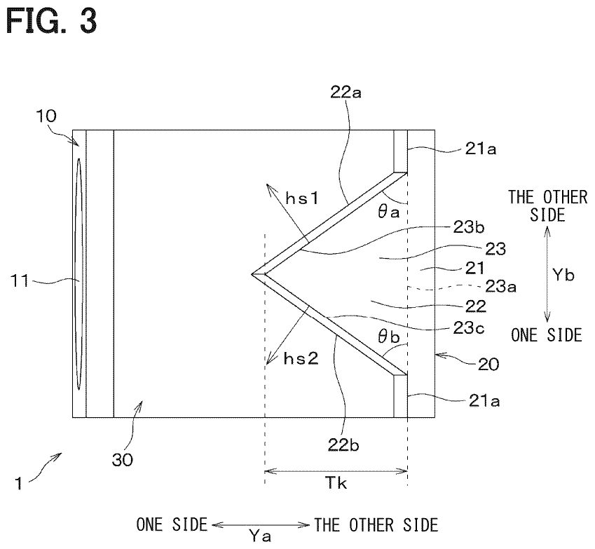

The triangular prisms 22 are arranged at equal interval in the lateral direction Yb. Each of the triangular prisms 22 is formed to protrude from the base layer 21 to one side in the stacking direction Ya. Each of the triangular prisms 22 is disposed to face one of the openings 11. As shown in FIGS. 2 and 3, each of the triangular prisms 22 has inclined surfaces 22a, 22b. In the triangular prisms 22, the inclined surface 22a is a first inclined surface disposed on the other side in the lateral direction Yb with respect to the inclined surface 22b. The second metal layer 20 has a pattern structure including the inclined surfaces 22a, 22b.

As shown in FIG. 3, the inclined surface 22a has a normal direction hs1 intersecting with the stacking direction Ya. The inclined surface 22a is formed to extend to one side in the stacking direction Ya as extending to one side in the lateral direction Yb. The inclined surface 22a is formed to extend to the other side in the stacking direction Ya as extending to the other side in the lateral direction Yb. The inclined surface 22b has a normal direction hs2 intersecting with the stacking direction Ya. The inclined surface 22b is a second inclined surface formed to extend to one side in the lateral direction Yb and to the other side in the stacking direction Ya.

The inclined surface 22b is formed to extend to one side in the stacking direction Ya as extending to the other side in the lateral direction Yb. When the triangular prisms 22 are arranged in the lateral direction Yb, the inclined surfaces 22a and the inclined surfaces 22b are arranged alternately in the lateral direction Yb. As shown in FIG. 3, each of the triangular prisms 22 has a triangular side surface 23 on one side in the vertical direction Yc. A base 23a of the side surface 23 is formed to extend along the lateral direction Yb. The side surface 23 has a side 23b and a side 23c located on one side of the base 23a in the stacking direction Ya. In this embodiment, an angle θa formed between the base 23a and the side 23b and an angle θb formed between the base 23a and the side 23c are set to be the same.

The side 23b constitutes one side of the inclined surface 22a in the vertical direction Yc. The side 23c constitutes one side of the inclined surface 22b in the vertical direction Yc. In the base layer 21 of FIG. 1 and FIG. 2, a bottom surface 21a is provided between two triangular prisms 22 adjacent to each other. The bottom surface 21a is formed to extend along the lateral direction Yb and the vertical direction Yc. In this manner, the second metal layer 20 has the inclined surfaces 22a, the inclined surfaces 22b, and the bottom surfaces 21a.

For convenience of explanation, the inclined surfaces 22a and the inclined surfaces 22b may be collectively referred to as inclined surface 22a, 22b hereinafter. In this embodiment, two triangular prisms 22 adjacent to each other are arranged such that a pair of inclined surfaces 22a, 22b face each other with the dielectric 30 interposed therebetween. The triangular prisms 22 are provided with the pairs of inclined surfaces 22a, 22b that face each other with the dielectric 30 interposed therebetween. The pairs of inclined surfaces 22a, 22b of this embodiment retroreflect electromagnetic waves transmitted through the dielectric 30, as described below.

The dielectric 30 is disposed between the first metal layer 10 and the second metal layer 20. Specifically, the dielectric 30 is disposed between the first metal layer 10 and the inclined surface 22a, 22b and the bottom surface 21a of the second metal layer 20. As will be described later, the dielectric 30 converts the electromagnetic waves incident through the openings 11 into heat due to dielectric loss, thereby attenuating the electromagnetic waves. In this embodiment, the dielectric 30 is, for example, PPS, that is, polyphenylene sulfide.

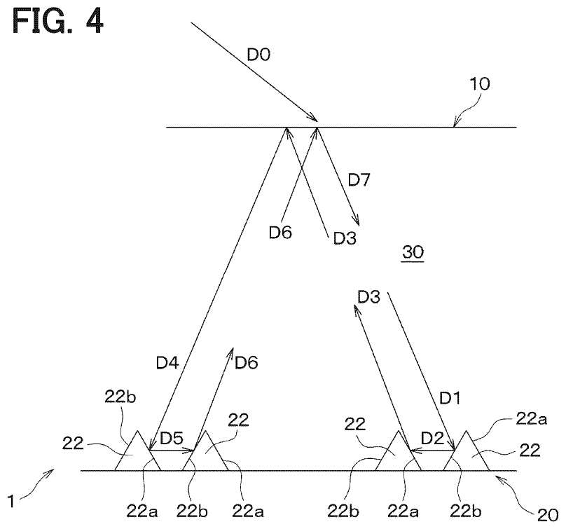

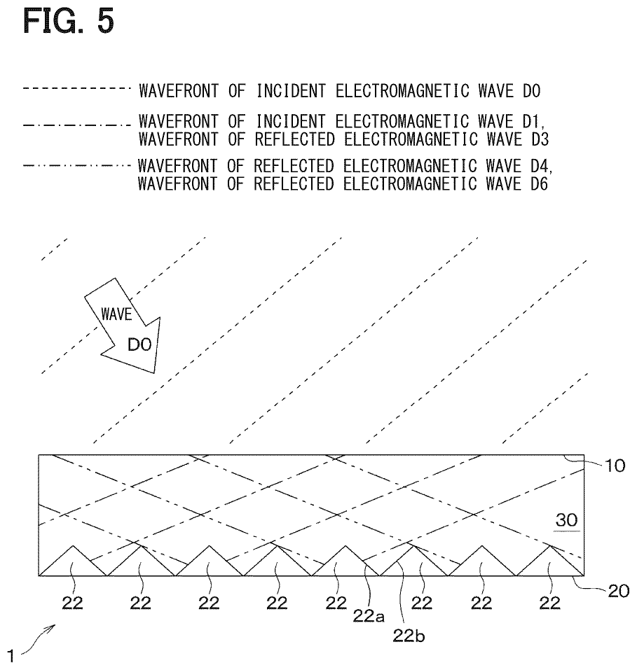

Next, the operation of the electromagnetic wave absorber 1 of this embodiment will be described with reference to FIGS. 2, 4 and 5. FIG. 4 is a schematic diagram showing multiple reflections of an electromagnetic wave between the first metal layer 10 and the second metal layer 20. FIG. 5 is a schematic diagram showing a positional relationship between the wavefront of the incident electromagnetic wave D0, D1 and the wavefront of the reflected electromagnetic wave D3, D4, D5. First, the incident electromagnetic wave D0 (i.e., unwanted electromagnetic wave) having a frequency within a predetermined frequency range arrives at the first metal layer 10 from one side in the stacking direction Ya. The incident electromagnetic wave D0 passes through the opening 11 of the first metal layer 10 and enters the dielectric 30 as an incident electromagnetic wave D1. The incident electromagnetic wave D0 travels through the dielectric 30 as the incident electromagnetic wave D1, and is then retroreflected by the pairs of inclined surfaces 22a, 22b of the second metal layer 20.

The inclined surfaces 22a, 22b adjacent to each other face each other with the dielectric 30 interposed therebetween. For example, one of the inclined surfaces 22a, 22b reflects the incident electromagnetic wave D1 as a reflected electromagnetic wave D2. The other of the inclined surfaces 22a, 22b reflects the reflected electromagnetic wave D2 as a reflected electromagnetic wave D3 (i.e., a first reflected electromagnetic wave). At this time, the reflected electromagnetic wave D3 is parallel to the traveling direction of the incident electromagnetic wave D1 and travels in the opposite direction to the incident electromagnetic wave D1. That is, the reflected electromagnetic wave D3 travels in the opposite direction along the traveling path of the incident electromagnetic wave D1.

As a result, the incident electromagnetic wave D1 is retroreflected by the pair of inclined surfaces 22a, 22b. In this manner, the reflected electromagnetic wave D3, which is parallel to the traveling direction of the incident electromagnetic wave D1 and travels in the opposite direction to the incident electromagnetic wave D1, travels within the dielectric 30 and is then reflected by the first metal layer 10. This reflected electromagnetic wave D3 travels through the dielectric 30 as a reflected electromagnetic wave D4 (i.e., a second reflected electromagnetic wave), and is then retroreflected again by the pairs of inclined surfaces 22a, 22b of the second metal layer 20. For example, one of the inclined surfaces 22a, 22b reflects the reflected electromagnetic wave D4 as a reflected electromagnetic wave D5.

The other of the pair of inclined surfaces 22a, 22b reflects the reflected electromagnetic wave D5 as a reflected electromagnetic wave D6. This reflected electromagnetic wave D6 (i.e., the third reflected electromagnetic wave) is parallel to the traveling direction of the reflected electromagnetic wave D4 and travels in the opposite direction to the traveling direction of the reflected electromagnetic wave D4. That is, the reflected electromagnetic wave D6 travels in the opposite direction along the traveling path of the reflected electromagnetic wave D4. The reflected electromagnetic wave D6 travels through the dielectric 30 and is then reflected by the first metal layer 10. At this time, the wavefront of the reflected electromagnetic wave D4 and the wavefront of the reflected electromagnetic wave D6 intersect as shown in FIG. 5.

The reflected electromagnetic wave D6 is reflected by the first metal layer 10 as a reflected electromagnetic wave D7 (i.e., a fourth reflected electromagnetic wave). In this manner, the incident electromagnetic wave D1 transmitted through the first metal layer 10 and the dielectric 30 is multi-reflected between the first metal layer 10 and the inclined surfaces 22a, 22b. At this time, as will be described later, when the wavefront of the reflected electromagnetic wave D4 coincides with the wavefront of the incident electromagnetic wave D1, the electromagnetic waves enter a resonant state. When the wavefront of the reflected electromagnetic wave D7 coincides with the wavefront of the incident electromagnetic wave D1, the electromagnetic waves are in a state of resonation between the first metal layer 10 and the inclined surface 22a, 22b. At this time, when the dielectric 30 resonates with the electromagnetic waves at a frequency within a predetermined frequency range, the dielectric 30 attenuates the unwanted electromagnetic waves by converting them into heat due to dielectric loss.

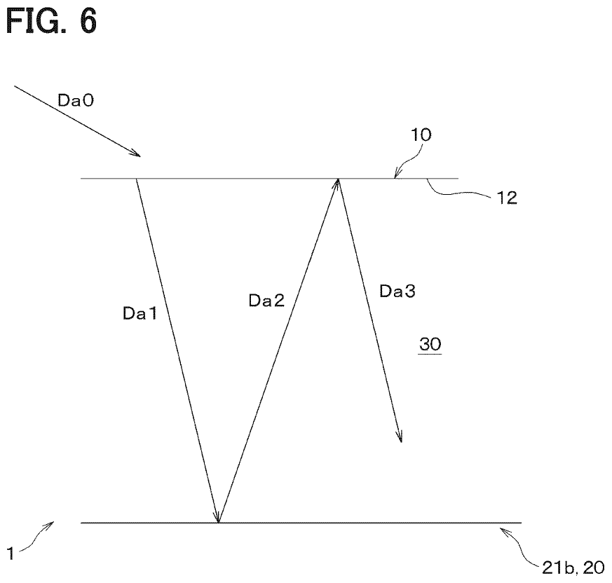

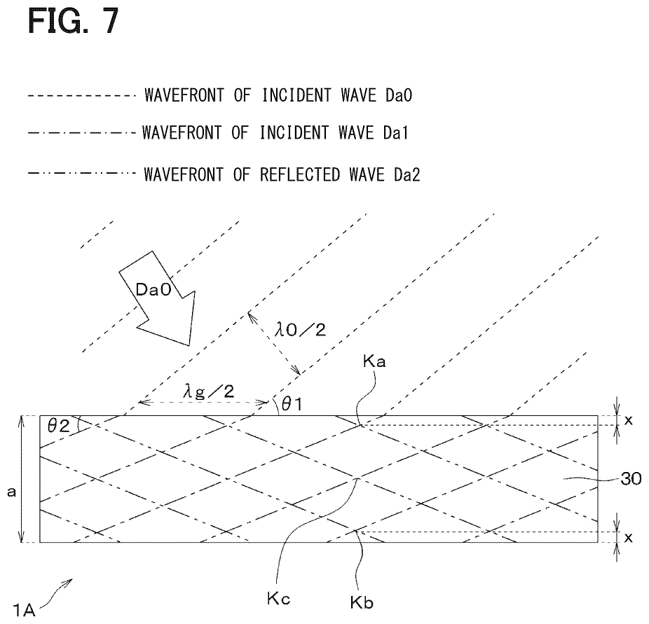

Next, a specific example of resonance of electromagnetic waves in an electromagnetic wave absorber 1A in a comparative example will be described with reference to FIGS. 6 and 7. FIG. 7 is a schematic diagram showing a configuration of the electromagnetic wave absorber 1A. In the comparative example, the second metal layer 20 of the electromagnetic wave absorber 1A has a flat surface in place of the inclined surfaces 22a and the inclined surfaces 22b of the second metal layer 20 of the electromagnetic wave absorber 1 of this embodiment. The flat surface is formed parallel to the lateral direction Yb and parallel to the vertical direction Yc. The openings 11 are omitted, in FIG. 7, in the first metal layer 10 of the electromagnetic wave absorber 1A.

FIG. 7 shows an example in which an electromagnetic wave incident on the electromagnetic wave absorber 1A is multi-reflected between the first metal layer 10 and the second metal layer 20. FIG. 7 shows a positional relationship between the wavefront of an incident electromagnetic wave Da1 and the wavefront of a reflected electromagnetic wave Da2 between the first metal layer 10 and the second metal layer 20. First, in the electromagnetic wave absorber 1A of FIG. 7, an incident electromagnetic wave Da0 arrives at the first metal layer 10 from one side in the stacking direction Ya, and the incident electromagnetic wave Da0 passes through the openings 11 of the first metal layer 10 and is incident on the dielectric 30.

The incident electromagnetic wave Da0 travels through the dielectric 30 as the incident electromagnetic wave Da1, and is then reflected by the second metal layer 20. The incident electromagnetic wave Da1 reflected by the second metal layer 20 passes through the dielectric 30 as the reflected electromagnetic wave Da2, and is then reflected by the first metal layer 10. The reflected electromagnetic wave Da2 reflected by the first metal layer 10 passes through the dielectric 30 toward the second metal layer 20 as a reflected electromagnetic wave Da3. At this time, when the wavefront of the reflected electromagnetic wave Da3 and the wavefront of the incident electromagnetic wave Da1 coincide with each other, the electromagnetic waves resonate within the dielectric 30.

Here, the dimension of the electromagnetic wave absorber 1A between the first metal layer 10 and the second metal layer 20 in the stacking direction Ya is taken as a thickness dimension “a”. Among plural intersections at which the wavefront of the reflected electromagnetic wave Da2 and the wavefront of the incident electromagnetic wave Da1 coincide, the intersection closest to one side in the stacking direction Ya is defined as an intersection point Ka. Among plural intersections at which the wavefront of the reflected electromagnetic wave Da2 and the wavefront of the incident electromagnetic wave Da1 coincide, the intersection closest to the other side in the stacking direction Ya is defined as an intersection point Kb. Between the intersection points Ka and Kb, there exists an intersection point Kc where the wavefront of the reflected electromagnetic wave Da2 and the wavefront of the incident electromagnetic wave Da1 coincide with each other.

In the electromagnetic wave absorber 1A, which is a comparative example, the distance between the one side in the stacking direction Ya and the intersection point Ka is taken as distance x, and a distance between the other side in the stacking direction Ya and the intersection point Kb is taken as distance x. Furthermore, the angle of incidence of the incident electromagnetic wave Da0 with respect to the dielectric 30 is defined as an incident angle θ1. The incident angle θ1 is a narrow angle formed between the wavefront of the incident electromagnetic wave Da0 and the lateral direction Yb. The refraction angle of the incident electromagnetic wave Da0 with respect to the dielectric 30 is defined as a refraction angle θ2. The refraction angle θ2 is a narrow angle formed between the wavefront of the incident electromagnetic wave Da1 and the lateral direction Yb. When the relative dielectric constant of the dielectric 30 is εr, the refraction angle θ2 is approximated by θ1/√εr.

The wavelength of the incident electromagnetic wave Da0 in the atmosphere is defined as λ0, and the wavelength of the incident electromagnetic wave Da1 in the lateral direction Yb within the dielectric 30 is defined as λg. When the frequency is f0 and the speed of light in the atmosphere is c0, the incident angle θ1, the wavelength λg, the wavelength λ0, the frequency f0, and the speed of light c0 have a relationship of Formula 1: λg·sin θ=λ0=f0·c0.

When the wavefront of the incident electromagnetic wave Da1 and the wavefront of the reflected electromagnetic wave Da3 coincide within the dielectric 30 of the electromagnetic wave absorber 1A, the electromagnetic waves are in a resonant state. In this case, the wavelength λg, the thickness dimension a, the distance x, and the refraction angle θ2 have a relationship of Formula 2: (a−2·x)/λg=tan(θ2).

Next, based on Formula 1 and Formula 2, the frequency f0 can be obtained from Formula 3: f0=c0·tan(θ2)/{(a−2·x)·sinθ}. That is, the frequency f0 can be determined by the speed of light c0, the refraction angle θ2, the incident angle θ1, the thickness dimension a, and the distance x. From this, the resonant frequency of the electromagnetic wave in the electromagnetic wave absorber 1A is determined as frequency f0.

Here, when the incident angle θ1 of the incident electromagnetic wave Da0 with respect to the electromagnetic wave absorber 1A changes, the refraction angle θ2 changes. Accordingly, the distance x changes, and therefore (a−2·x) changes. Therefore, when the incident angle θ1 changes, the frequency f0, which is the resonant frequency, changes. For example, when the incident angle θ1 increases, (a−2·x) decreases, and the resonant frequency f0 increases. However, in the electromagnetic wave absorber 1A, which is a comparative example, the distance x is determined by the positional relationship between the incident electromagnetic wave Da1 and the reflected electromagnetic wave Da2.

Therefore, when the incident angle θ1 increases, as shown in FIGS. 8 and 9, the reflected electromagnetic wave Da3 moves significantly to the right in in FIGS. 8 and 9 relative to the incident electromagnetic wave Da1. Therefore, when the incident angle θ1 changes, the positional relationship between the wavefront of the incident electromagnetic wave Da1 and the wavefront of the reflected electromagnetic wave Da3 changes significantly, and therefore (a−2·x) changes significantly. As a result, the amount of change in the frequency f0 when the incident angle θ1 changes increases. FIG. 8 is a diagram showing the positional relationship between the wavefront of the incident electromagnetic wave Da1 and the wavefront of the reflected electromagnetic wave Da2 before the incident angle θ1 changes. FIG. 9 is a diagram showing the positional relationship between the wavefront of the incident electromagnetic wave Da1 and the wavefront of the reflected electromagnetic wave Da2 after the incident angle θ1 is changed.

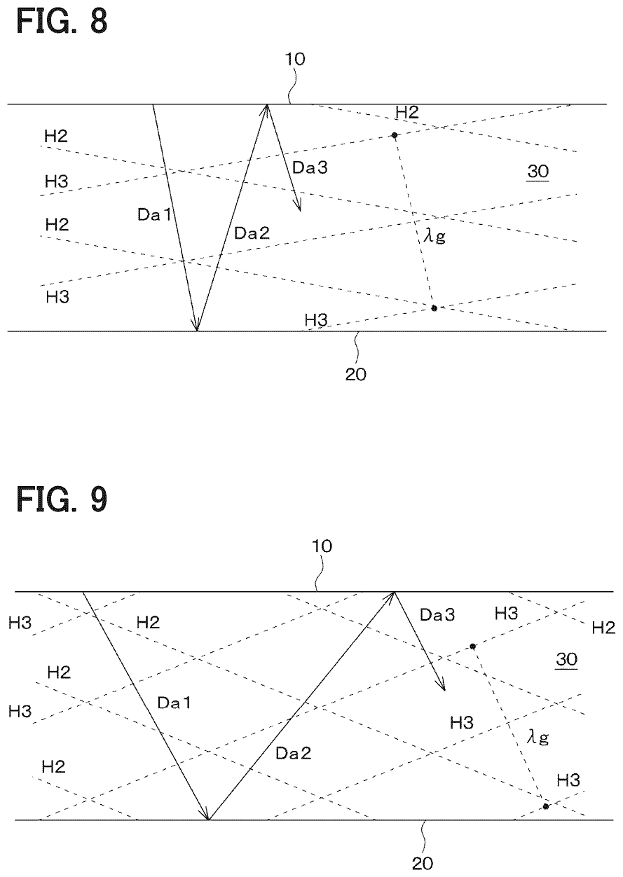

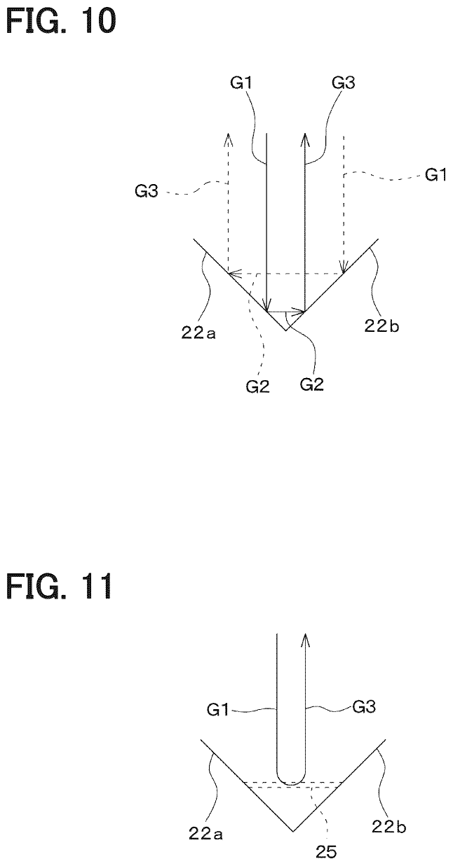

In contrast to this, in the electromagnetic wave absorber 1 of this embodiment, when the incident angle θ1 changes, it is possible to suppress the change in the positional relationship between the incident electromagnetic wave D1 and the reflected electromagnetic wave D3. In this embodiment, as shown in FIGS. 10, 11, 12, and 13, the inclined surfaces 22a, 22b retroreflect the incident electromagnetic wave D1 that has passed through the opening 11 of the first metal layer 10 and the dielectric 30 as the reflected electromagnetic wave D3. At this time, as shown in FIGS. 11 and 13, the incident electromagnetic wave D1 is retroreflected by the effective reflecting surface 25. The effective reflecting surface 25 is an imaginary reflecting surface formed by the inclined surfaces 22a, 22b adjacent to each other. The effective reflecting surface 25 is provided for convenience of explanation. Here, the angle formed between the wavefront of the incident electromagnetic wave D1 and the lateral direction Yb is defined as the refraction angle θ2.

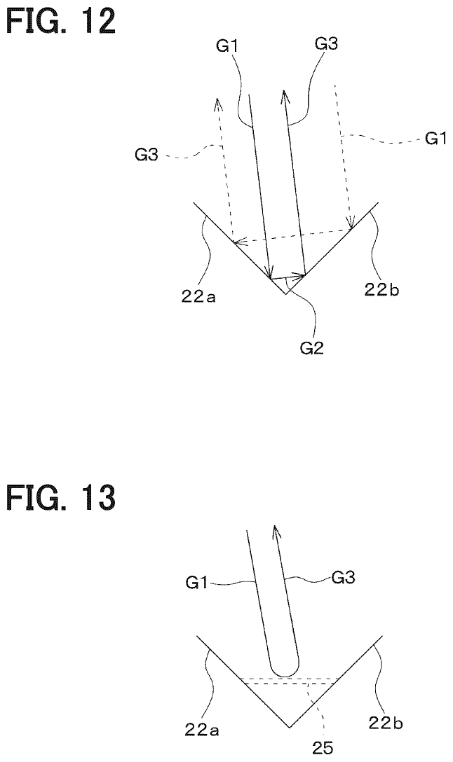

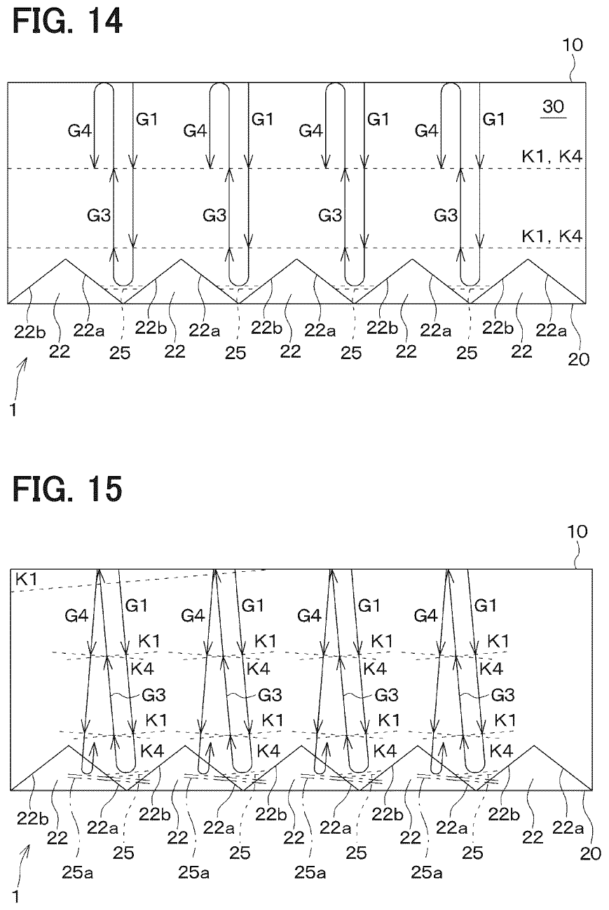

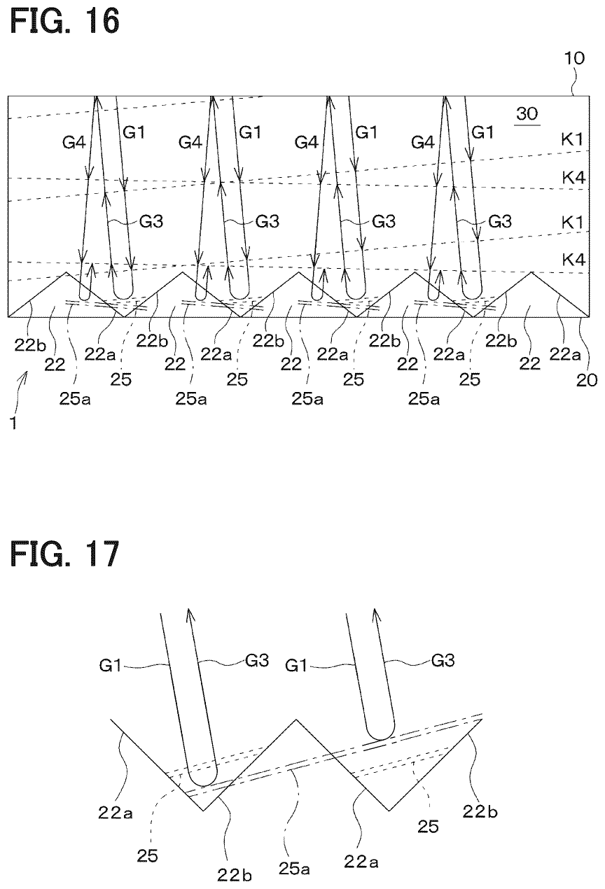

As shown in FIG. 14, in case where the incident electromagnetic wave D1 travels through the dielectric 30 in the stacking direction Ya and the refraction angle θ2 is 0°, when the wavefront K1 of the incident electromagnetic wave D1 and the wavefront K4 of the reflected electromagnetic wave D4 coincide with each other, the electromagnetic waves resonate. FIG. 14 shows a specific example in which four electromagnetic waves G1 to G4 act in parallel. As shown in FIGS. 15 and 16, in case where the refraction angle θ2 of the incident electromagnetic wave D1 is 5°, when the wavefront K1 of the incident electromagnetic wave D1 and the wavefront K4 of the reflected electromagnetic wave D4 partially coincide with each other, the electromagnetic waves enter a resonant state. The electromagnetic waves G1 to G4 represent a transmission path and a traveling direction of the electromagnetic wave. In FIGS. 10 and 12, the solid line represents a state where the electromagnetic wave is reflected in order of the inclined surface 22a and the inclined surface 22b. The dashed line represents a state where the electromagnetic wave is reflected in order of the inclined surface 22b and the inclined surface 22a. The traveling direction is opposite to each other between the solid line and the dashed line.

FIG. 15 shows an example in which the wavefront K1 of the incident electromagnetic wave D1 and the wavefront K4 of the reflected electromagnetic wave D4 match at some locations and do not match at the other locations. FIG. 16 shows a specific example in which the wavefront K1 and the wavefront K4 coincide at two points. The wavefront K1 is obtained by connecting and synthesizing the wavefronts of four electromagnetic waves G1, and the wavefront K4 is obtained by connecting and synthesizing the wavefronts of four electromagnetic waves G4. In this case, the incident electromagnetic wave D1 and the reflected electromagnetic wave D4 are each retroreflected by the effective reflecting surface 25. When the refraction angle θ2 of the incident electromagnetic wave D1 is greater than 5°, as shown in FIG. 17, the incident electromagnetic wave D1 and the reflected electromagnetic wave D4 are each retroreflected by the effective reflecting surface 25a.

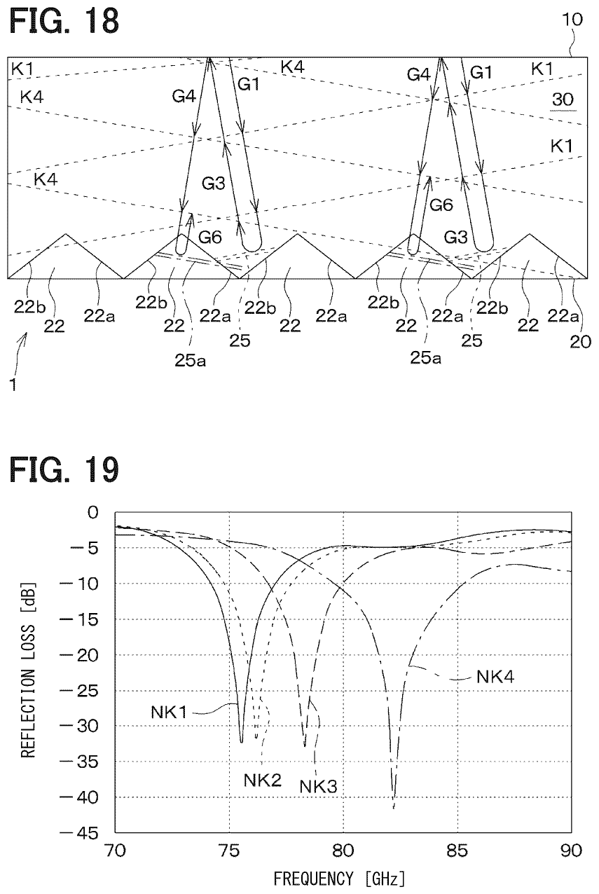

The effective reflecting surface 25a is an imaginary reflecting surface formed by two pairs of inclined surfaces 22a, 22b adjacent to each other. The effective reflecting surface 25a is provided for convenience of explanation. As shown in FIG. 18, when the refraction angle θ2 of the incident electromagnetic wave D1 is 10°, the incident electromagnetic wave D1 and the reflected electromagnetic wave D4 are each retroreflected by the effective reflecting surface 25a. When the wavefront K1 of the incident electromagnetic wave D1 and the wavefront K4 of the reflected electromagnetic wave D4 partially coincide with each other, the electromagnetic waves are in a resonant state. FIG. 18 shows a specific example in which the wavefront K1 and the wavefront K4 coincide at five points. The wavefront K1 is obtained by connecting and synthesizing the wavefronts of two electromagnetic waves G1, and the wavefront K4 is obtained by connecting and synthesizing the wavefronts of two electromagnetic waves G4. In FIG. 18, the electromagnetic waves G1, G3, G4, G6 travel in parallel to each other.

In this way, when the incident angle θ1 of the incident electromagnetic wave D1 changes and the refraction angle θ2 changes, the incident electromagnetic wave D1 and the reflected electromagnetic wave D4 are each retroreflected by the effective reflecting surface 25, 25a. Therefore, when the refraction angle θ2 changes, the change in the positional relationship between the incident electromagnetic wave D1 and the reflected electromagnetic wave D4 is suppressed. In other words, when the refraction angle θ2 changes, the change in the positional relationship between the wavefront of the incident electromagnetic wave D1 and the wavefront of the reflected electromagnetic wave D4 is suppressed. This makes it possible to suppress a change in the resonant frequency that occurs when the wavefront of the incident electromagnetic wave D1 and the wavefront of the reflected electromagnetic wave D4 coincide with each other in case where the incident angle θ1 changes.

When the incident angle θ1 of the incident electromagnetic wave D1 changes and the refraction angle θ2 changes, the change in the positional relationship between the incident electromagnetic wave D1 and the reflected electromagnetic wave D7 is suppressed. In other words, when the refraction angle θ2 changes, the change in the positional relationship between the wavefront of the incident electromagnetic wave D1 and the wavefront of the reflected electromagnetic wave D7 is suppressed. This makes it possible to suppress a change in the resonant frequency that occurs when the wavefront of the incident electromagnetic wave D1 and the wavefront of the reflected electromagnetic wave D7 coincide with each other in case where the incident angle θ1 changes. As described above, in this embodiment, in the electromagnetic wave absorber 1, a change in the resonant frequency can be suppressed when the incident angle θ1 of the incident electromagnetic wave arriving from one side in the stacking direction Ya changes. In other words, when the incident angle θ1 changes, the resonant frequency of the electromagnetic wave can be restricted from deviating from a predetermined frequency range. Next, the attenuation amount of electromagnetic wave of the electromagnetic wave absorber 1 of this embodiment will be described with reference to FIGS. 19, 20, 21 and 22.

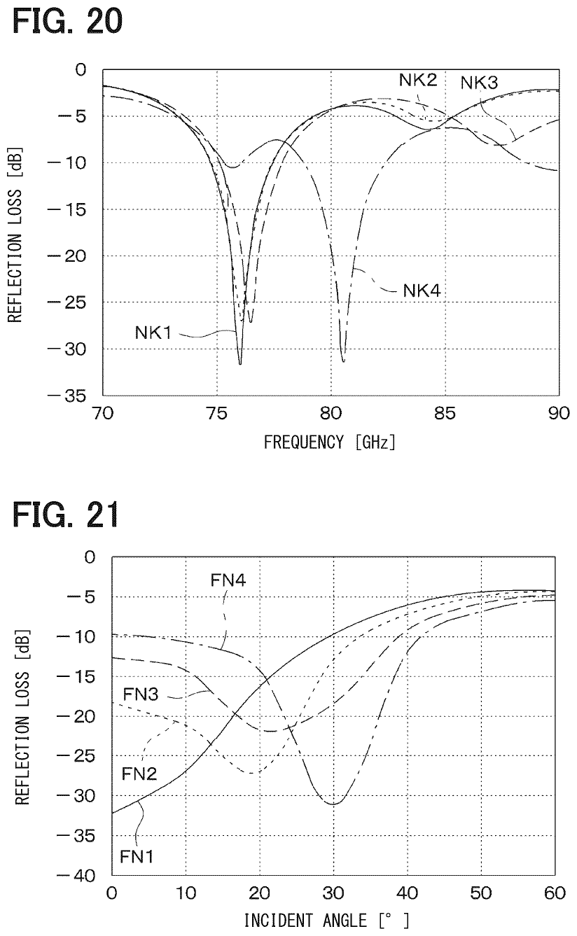

FIG. 19 is a graph in which the vertical axis represents a reflection loss [dB] of the electromagnetic wave by the electromagnetic wave absorber 1A of the comparative example and the horizontal axis represents a frequency [GHz] of the electromagnetic wave, when an electromagnetic wave of 76 GHz is incident on the electromagnetic wave absorber 1A. FIG. 20 is a graph in which the vertical axis represents a reflection loss [dB] of the electromagnetic wave by the electromagnetic wave absorber 1 of this embodiment and the horizontal axis represents a frequency [GHz] of the electromagnetic wave, when an electromagnetic wave of 76 GHz is incident on the electromagnetic wave absorber 1 of this embodiment. In FIGS. 19 and 20, a graph NK1 indicates a reflection loss of the electromagnetic wave when the incident angle θ1 is 0°. A graph NK2 shows a reflection loss of the electromagnetic wave when the incident angle θ1 is 20°. A graph NK3 shows a reflection loss of the electromagnetic wave when the incident angle θ1 is 40°. A graph NK4 shows a reflection loss of the electromagnetic wave when the incident angle θ1 is 60°.

In the electromagnetic wave absorber 1A of the comparative example, the reflection loss of the electromagnetic wave represents a ratio of the outgoing electromagnetic wave to the incident electromagnetic wave in the electromagnetic wave absorber 1A, expressed in dB. The reflection loss of the electromagnetic wave means that the greater the absolute value of the reflection loss, the greater the attenuation amount of the electromagnetic wave by the electromagnetic wave absorber 1A. The incident electromagnetic wave is an electromagnetic wave incident on the electromagnetic wave absorber 1A, and the outgoing electromagnetic wave is an electromagnetic wave that is outgoing from the electromagnetic wave absorber 1A. In the electromagnetic wave absorber 1 of this embodiment, the reflection loss of the electromagnetic wave is a ratio of the outgoing electromagnetic wave to the incident electromagnetic wave, expressed in dB. The incident electromagnetic wave is an electromagnetic wave incident on the electromagnetic wave absorber 1, and the outgoing electromagnetic wave is an electromagnetic wave that is outgoing from the electromagnetic wave absorber 1. The reflection loss of the electromagnetic wave means that the greater the absolute value of the reflection loss, the greater the attenuation amount of the electromagnetic wave by the electromagnetic wave absorber 1.

In the graphs NK1, NK2, NK3, NK4 of FIGS. 19 and 20, the absolute value of the reflection loss of the electromagnetic wave is maximum at the resonant frequency. In FIGS. 19 and 20, the resonant frequency when the incident angle θ1 is 20° is higher than the resonant frequency when the incident angle θ1 is 0°. The resonant frequency when the incident angle θ1 is 40° is higher than the resonant frequency when the incident angle θ1 is 20°. The resonant frequency when the incident angle θ1 is 60° is higher than the resonant frequency when the incident angle θ1 is 40°.

Here, in the electromagnetic wave absorber 1A of the comparative example, if the resonant frequency when the incident angle θ1 is 0° is defined as a reference resonant frequency, when the incident angle θ1 becomes larger than 0°, the resonant frequency will change significantly with respect to the reference resonant frequency. In the electromagnetic wave absorber 1 of this embodiment, when the incident angle θ1 becomes larger than 0°, the resonant frequency becomes larger than the reference resonant frequency. However, in this embodiment, when the incident angle θ1 becomes larger than 0°, the amount of change in the resonant frequency with respect to the reference resonant frequency can be suppressed compared with the comparative electromagnetic wave absorber 1A.

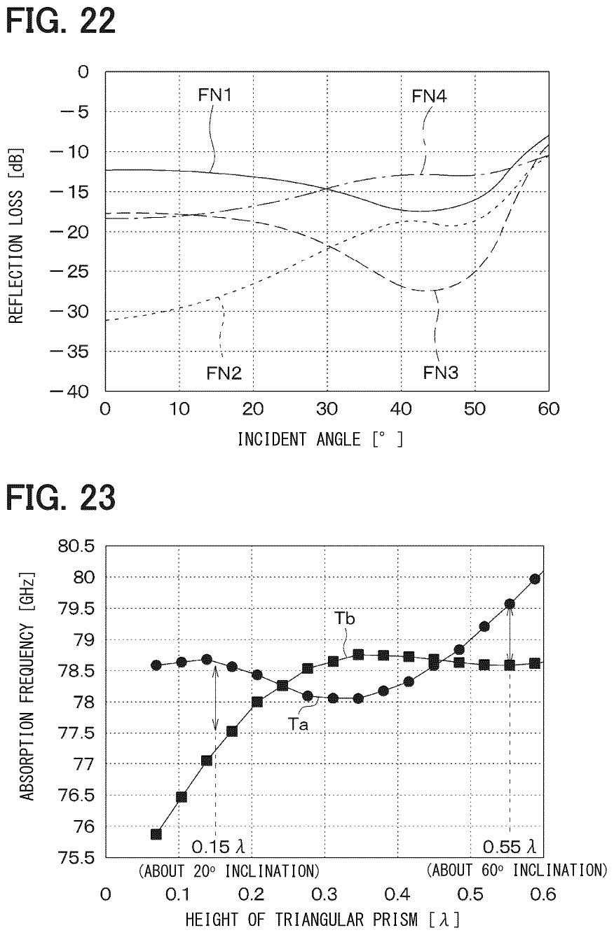

As a result, in this embodiment, it is possible to suppress a change in the resonant frequency when the incident angle θ1 changes. Therefore, when the incident angle θ1 changes, the resonant frequency can be restricted from deviating from a predetermined frequency range. FIG. 21 is a graph in which the vertical axis represents the reflection loss [dB] of the electromagnetic wave caused by the electromagnetic wave absorber 1A as a comparison example, and the horizontal axis represents the incident angle [°] of the electromagnetic wave. FIG. 22 is a graph in which the vertical axis represents the reflection loss [dB] of the electromagnetic wave caused by the electromagnetic wave absorber 1 of this embodiment, and the horizontal axis represents the incident angle [°] of the electromagnetic wave. In FIGS. 21 and 22, the graph FN1 shows the reflection loss of the electromagnetic wave when the frequency of the electromagnetic wave is 75.5 GHz, and the graph FN2 shows the reflection loss of the electromagnetic wave when the frequency of the electromagnetic wave is 76.0 GHz.

The graph FN3 shows the reflection loss of the electromagnetic wave when the frequency of the electromagnetic wave is 76.5 GHz. The graph FN4 shows the reflection loss of the electromagnetic wave when the frequency of the electromagnetic wave is 77.0 GHz. As shown in FIG. 21, in the comparative electromagnetic wave absorber 1A, as can be seen from the graphs FN1, FN2, FN3, FN4, the reflection loss of the electromagnetic wave changes greatly depending on the incident angle θ1. In contrast, as shown in FIG. 22, in this embodiment, as can be seen from the graphs FN1, FN2, FN3, FN4, the amount of change in the reflection loss of the electromagnetic wave is small when the incident angle θ1 changes.

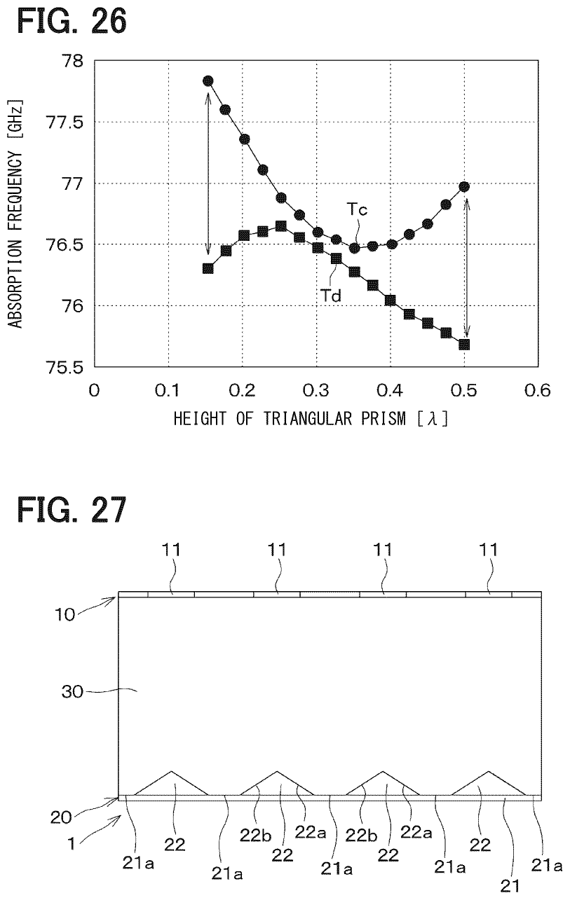

Next, specific examples of the triangular prisms 22 in the second metal layer 20 of this embodiment will be described with reference to FIGS. 23, 24, 25, 26, 27, and 28. FIG. 23 is a graph in which the vertical axis represents the absorption frequency of the electromagnetic wave absorber 1 and the horizontal axis represents a calculated value obtained by dividing the dimension Tk of the inclined surface 22a, 22b of the triangular prism 22 in the stacking direction Ya by λ which is the wavelength of the electromagnetic wave traveling within the dielectric 30. In FIGS. 23 and 26, the height of the triangular prism [λ] represents the calculated value Tk/λ. The absorption frequency is a frequency (for example, a resonant frequency) at which the electromagnetic wave absorber 1 can attenuate the electromagnetic wave by −10 dB or more. The wavelength of the electromagnetic wave traveling within the dielectric 30 is λ, and the horizontal axis of FIGS. 23 and 26 represents the height of the triangular prism 22 when λ is used as a unit so as to indicate information related to the dimension Tk of the inclined surface 22a, 22b in the stacking direction Ya.

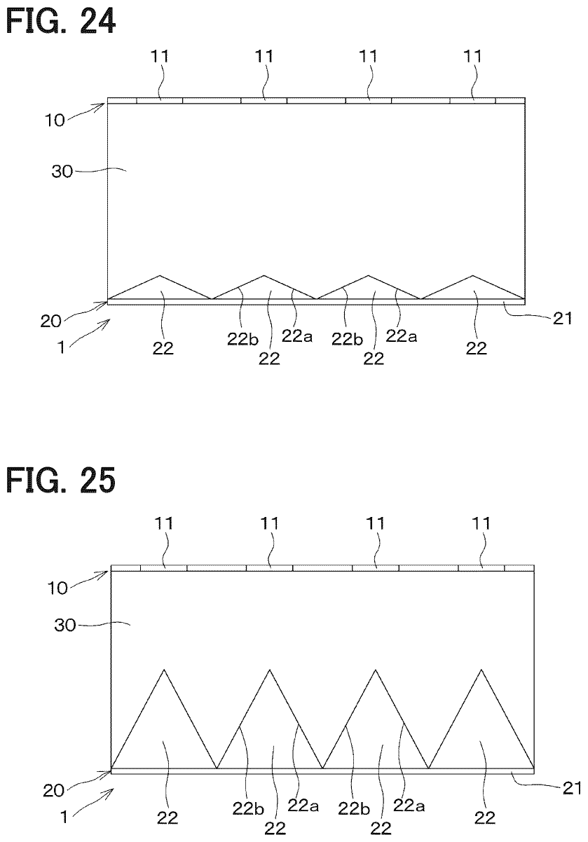

FIG. 23 is a diagram showing the relationship between the absorption frequency and the calculated value Tk/λ in the electromagnetic wave absorber 1 not provided with the bottom surface 21a as shown in FIGS. 24 and 25. A graph Ta in FIG. 23 shows the relationship between the absorption frequency and the calculated value Tk/λ when the incident angle θ is 0°. A graph Tb shows the relationship between the absorption frequency and the calculated value Tk/λ when the incident angle θ is 40°. The absolute value of the difference between the absorption frequency of the graph Ta and the absorption frequency of the graph Tb is |ΔF|. As can be seen from the graphs Ta and Tb, when the calculated value Tk/λ is 0.15 or more and 0.55 or less, |ΔF| can be made equal to or less than 1 GHz.

Therefore, in the electromagnetic wave absorber 1, if the dimension Tk of the inclined surface 22a, 22b in the stacking direction Ya is 0.15·λ or more and 0.55·λ or less, it is possible to attenuate electromagnetic waves by −10 dB or more while keeping the change in absorption frequency to 1 GHz or less. FIG. 24 shows the triangular prism 22 when the angle θa, θb of the inclined surface 22a, 22b is 20°in the electromagnetic wave absorber 1 in which the calculated value Tk/λ is 0.15. FIG. 25 shows the triangular prism 22 when the angle θa, θb of the inclined surface 22a, 22b is 60° in the electromagnetic wave absorber 1 when the calculated value Tk/λ is 0.55.

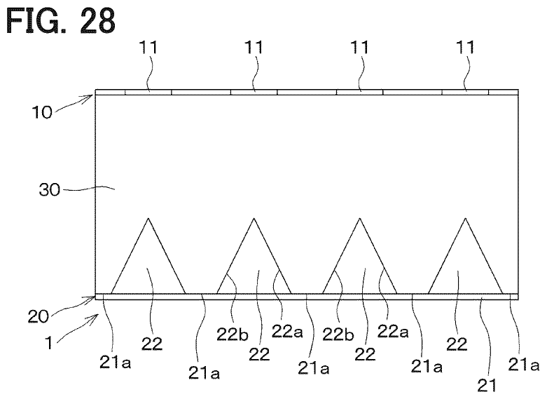

FIG. 26 is a graph in which the vertical axis represents the absorption frequency, which is the frequency at which the electromagnetic wave absorber 1 can attenuate electromagnetic waves by −10 dB or more, and the horizontal axis represents the calculated value Tk/λ as the height of the triangular prism [λ]. The wavelength of the electromagnetic wave propagating within the dielectric 30 is λ. The calculated value Tk/λ is obtained by dividing the dimension Tk of the inclined surface 22a, 22b of the triangular prism 22 in the stacking direction Ya by λ. FIG. 26 is a diagram showing the relationship between the absorption frequency and the calculated value Tk/λ in the electromagnetic wave absorber 1 having the bottom surface 21a as shown in FIGS. 27 and 28.

A graph Tc in FIG. 26 shows the relationship between the absorption frequency and the calculated value Tk/λ when the incident angle θ is 0°. A graph Td shows the relationship between the absorption frequency and the calculated value Tk/λ when the incident angle θ is 40°. Here, the absolute value of the difference between the absorption frequency of the graph Tc and the absorption frequency of the graph Td is |ΔF|. As can be seen from the graphs Tc and Td, when the calculated value Tk/λ is 0.15 or more and 0.5 or less, |ΔF| can be made 2 GHz or less.

As a result, in the electromagnetic wave absorber 1, when the calculated value Tk/λ is 0.15 or more and 0.5 or less, in other words, the height of the triangular prism [λ] is 0.15λ or more and 0.5λ or less, it is possible to attenuate the electromagnetic waves by −-10 dB or more while keeping the change in the absorption frequency to 2 GHz or less. FIG. 27 shows the triangular prism 22 when the angle θa, θb of the inclined surface 22a, 22b is 20° in the electromagnetic wave absorber 1 in which calculated value Tk/λ is 0.15. FIG. 28 shows the triangular prism 22 when the angle θa, θb of the inclined surface 22a, 22b is 60° in the electromagnetic wave absorber 1 in which the calculated value Tk/λ is 0.5.

In recent years, a radar device is mounted on an automobile as obstacle sensor. When a radar is installed in a vehicle, radio waves are multi-reflected between the radar board and the bumper, or between the radome and the bumper, to interfere with the radar's original transmitting and receiving signals, degrading the radar's performance (for example, maximum detection distance and direction estimation accuracy). There is a need for a low-cost, compact countermeasure against this multi-reflected radio wave. In recent years, with the improvement of processing technology, the antenna section may be formed using a metal-coated resin waveguide, and there is an increasing need for measures to absorb the reflected electromagnetic waves (i.e., unwanted electromagnetic waves) on the surface of the radar board.

In response to this, a method can be considered in which a dummy antenna is placed on the surface of the radar board as an electromagnetic wave absorber to absorb the electromagnetic waves reflected on the surface of the radar board. Thermal conversion is performed using a resistor while resonating with a resonant element on the board. Although this technique is useful in principle, if it is to be implemented in an antenna using a metal-coated resin waveguide, the waveguide will have to be routed long, which will increase the size of the electromagnetic wave absorber.

An electromagnetic wave absorber absorbs the reflected electromagnetic waves on the surface of the radar board. The wave absorber has a full-surface conductor layer, a dielectric layer made of one or more dielectric layers, and a pattern layer having patterns made of conductor and sequentially stacked. In the wave absorber, the pattern is different, in the pattern layer, from the adjacent pattern in at least one of size and shape. This makes it possible to widen the bandwidth and angle of incident electromagnetic waves, however, since a multi-layered resin structure is required in principle, applying the wave absorber to a metal-coated resin waveguide structure results in high costs.

The electromagnetic wave absorber may have a sheet-shape to absorb oblique incidence, i.e., electromagnetic waves incident from a direction inclined with respect to the direction perpendicular to the sheet surface, in the same way as normal incidence, so long as the inclination is within a certain range. In this case, it is necessary to control the particle shape and packing rate of the soft magnetic metal powder, and the thickness of the sheet.

In contrast, in this embodiment, these issues with the electromagnetic wave absorber do not occur. In the electromagnetic wave absorber 1, it is easy to arrange around an antenna using a metal-coated resin waveguide, at low cost. It is possible to attenuate electromagnetic waves of frequencies within a predetermined frequency range even if the incident angle θ changes. According to this embodiment, the electromagnetic wave absorber 1 includes the first metal layer 10, the second metal layer 20, and the dielectric 30. The first metal layer 10 has the plural openings 11 open in the stacking direction Ya and allow the incident electromagnetic wave D0 of a frequency within a predetermined frequency range from one side in the stacking direction Ya to pass through. The dielectric 30 is disposed on the other side of the first metal layer 10 in the stacking direction Ya, to transmit the incident electromagnetic wave D1 that has passed through the openings 11. The second metal layer 20 is disposed on the other side of the dielectric 30 in the stacking direction Ya, and has the inclined surface 22a, 22b to retroreflect the incident electromagnetic wave D1 that has passed through the dielectric 30.

The incident electromagnetic wave D1 that passes through the dielectric 30 is multiple-reflected between the inclined surface 22a, 22b and the first metal layer 10, causing the electromagnetic wave to resonate at a frequency within a predetermined frequency range, and the dielectric 30 attenuates the electromagnetic wave. Specifically, the incident electromagnetic waves D1 transmitted through the openings 11 in the first metal layer 10 and the dielectric 30 are retroreflected by the inclined surface 22a, 22b as a reflected electromagnetic wave D3. The reflected electromagnetic wave D3 passes through the dielectric 30 and is then reflected by the first metal layer 10 as a reflected electromagnetic wave D4. The reflected electromagnetic wave D4 travels through the dielectric 30. At this time, the wavefront of the reflected electromagnetic wave D4 coincides with the wavefront of the incident electromagnetic wave D1, causing the electromagnetic waves to resonate. Therefore, the dielectric 30 converts the electromagnetic waves into heat due to dielectric loss, in the state where the electromagnetic waves resonate, thereby attenuating the electromagnetic waves.

Therefore, in this embodiment, the incident electromagnetic wave D1 is retroreflected by the inclined surface 22a, 22b. When the incident angle θ changes, the change in the positional relationship between the incident electromagnetic wave D1 and the reflected electromagnetic wave D4 can be suppressed. Therefore, when the incident angle θ changes, it is possible to suppress a change in the positional relationship between the wavefront of the incident electromagnetic wave D1 and the wavefront of the reflected electromagnetic wave D4. Thus, if the incident angle θ changes, the change in the resonant frequency of the electromagnetic wave can be suppressed.

Therefore, if the incident angle θ changes, the electromagnetic waves are resonated at frequencies within the predetermined frequency range, and the electromagnetic waves having frequencies within the predetermined frequency range are converted into heat. As a result, it is possible to provide the electromagnetic wave absorber 1 that efficiently attenuates electromagnetic waves having frequencies within a predetermined frequency range if the incident angle θ changes. The electromagnetic wave absorber of this embodiment provides the following operational effects (a), (b), (c), (d) and (e).

(a) The second metal layer 20 has the inclined surface 22a whose normal direction hs1 is inclined relative to the stacking direction Ya to approach one side in the stacking direction Ya as extending to one side in the lateral direction Yb. The second metal layer 20 has the inclined surface 22b arranged on one side of the inclined surface 22a in the lateral direction Yb, so that the normal direction hs2 is inclined relative to the stacking direction Ya to approach one side in the stacking direction Ya as extending to the other side in the lateral direction Yb. When one of the inclined surfaces 22a, 22b reflects the incident electromagnetic wave D1, the other of the inclined surfaces 22a, 22b reflects the incident electromagnetic wave D1 reflected by the one as a reflected electromagnetic wave D2. At this time, the other reflects the reflected electromagnetic wave D2 in the opposite direction to the incident electromagnetic wave D1 along the traveling direction of the incident electromagnetic wave D1, thereby retroreflecting the incident electromagnetic wave D1.

When one of the inclined surfaces 22a, 22b reflects the reflected electromagnetic wave D4, the other of the inclined surfaces 22a, 22b reflects the reflected electromagnetic wave D4 reflected by the one as a reflected electromagnetic wave D5. At this time, the other reflects the reflected electromagnetic wave D5 in the opposite direction to the reflected electromagnetic wave D4, along the traveling direction of the reflected electromagnetic wave D4, thereby retroreflecting the reflected electromagnetic wave D4. This makes it possible to appropriately retroreflect the incident electromagnetic wave D1 and the reflected electromagnetic wave D4 with a simple configuration such as the inclined surface 22a, 22b.

(b) The second metal layer 20 has the plural inclined surfaces 22a, 22b arranged alternately in the lateral direction Yb. Therefore, the incident electromagnetic wave D1 and the reflected electromagnetic wave D4 can be appropriately retroreflected.

(c) The triangular prisms 22 are respectively disposed to face the openings 11. This allows the incident electromagnetic wave D1 and the reflected electromagnetic wave D4 to be appropriately retroreflected.

(d) In the electromagnetic wave absorber 1, when the wavelength of the electromagnetic wave traveling within the dielectric 30 of the electromagnetic wave absorber 1 is λ, the dimension Tk of the inclined surface 22a, 22b in the stacking direction Ya is set within a range between 0.15·λ and 0.55·λ.

Therefore, if the incident angle θ1 of the electromagnetic wave is changed from 0° to 40°, it is possible to attenuate by −10 dB or more while keeping the change in the absorption frequency to 1 GHz or less. The absorption frequency is a frequency of the electromagnetic wave that resonates in the electromagnetic wave absorber 1 (for example, the resonant frequency). As a result, if the incident angle θ1 of the electromagnetic wave is changed from 0° to 40°, the resonant frequency can be restricted from changing, and the resonant frequency can be kept within a predetermined frequency range. Therefore, a sufficient amount of attenuation of electromagnetic waves can be ensured in the electromagnetic wave absorber 1.

(e) The second metal layer 20 includes the triangular prisms 22 having the inclined surfaces 22a, 22b as plural reflectors according to the present disclosure. In the second metal layer 20, the triangular prisms 22 are arranged in the lateral direction Yb, so that the inclined surfaces 22a, 22b are arranged alternately one by one in the lateral direction Yb. Therefore, in the second metal layer 20, the plural reflectors can be appropriately configured to retroreflect the incident electromagnetic wave D1 and the reflected electromagnetic wave D4.

### Second Embodiment

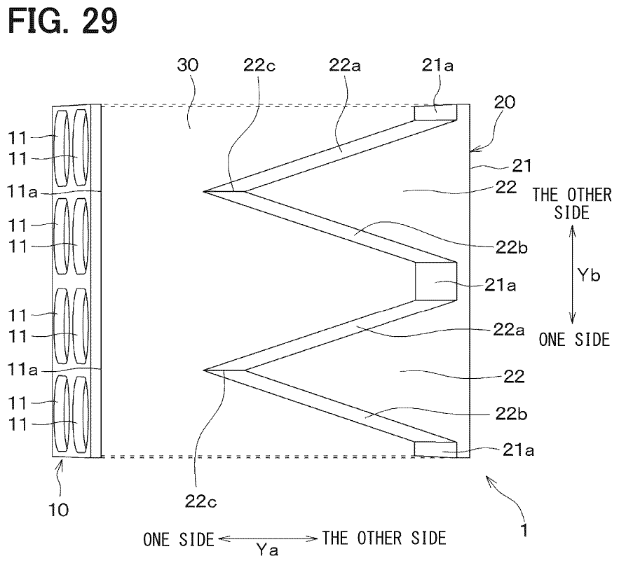

In the first embodiment, in the electromagnetic wave absorber 1, each of the triangular prisms 22 is arranged to face one of the openings 11. Alternatively, in the second embodiment, as shown in FIG. 29, the triangular prisms 22 are arranged to face two adjacent openings 11.

Specifically, the triangular prisms 22 are arranged such that the apex 22c of the triangular prism 22 faces the intermediate portion 11a between the two adjacent openings 11. The triangular prisms 22 are arranged such that the inclined surface 22b of the triangular prism 22 faces one of the two adjacent openings 11. The triangular prisms 22 are arranged such that the inclined surface 22a faces the opening 11 on the other side, of the two adjacent openings 11. As a result, each of the triangular prisms 22 is disposed to face two adjacent openings 11. That is, the triangular prism 22 is arranged to face the openings 11, the number of which is an integer equal to or greater than two (for example, two). In this embodiment, the number of openings 11 is an integer multiple (for example, twice) the number of triangular prisms 22.

### Third Embodiment

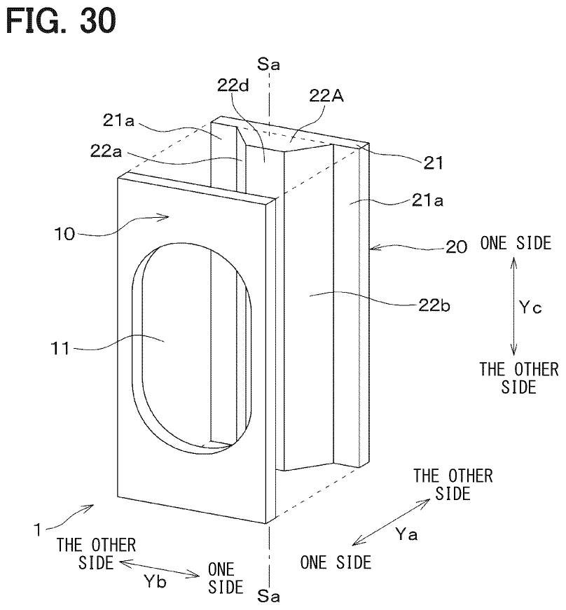

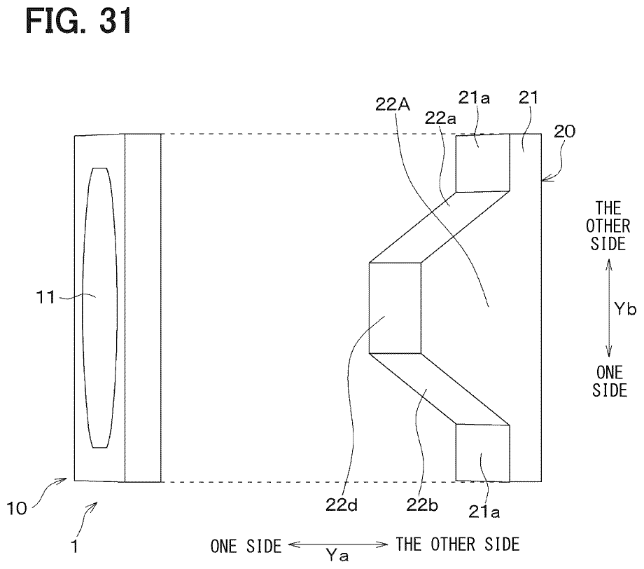

In the first and second embodiments, the triangular prism 22 having the inclined surfaces 22a, 22b is used as the multiple reflectors of the present disclosure. Alternatively, in the third embodiment, as shown in FIGS. 30 and 31, a rectangular prism 22A formed into a rectangular prism shape having inclined surfaces 22a, 22b may be used as plural reflectors of the present disclosure. FIG. 30 is a perspective view showing the rectangular prism 22A of the electromagnetic wave absorber 1 of this embodiment. FIG. 31 is a perspective view showing one side of the rectangular prism 22A of the electromagnetic wave absorber 1 of this embodiment in the vertical direction Yc.

In the present embodiment, the rectangular prism 22A has a rectangular cross-section taken along an imaginary plane parallel to the stacking direction Ya and parallel to the lateral direction Yb. Each of the rectangular prisms 22A is disposed to face one of the openings 11. A top surface 22d is formed between the inclined surfaces 22a, 22b of the rectangular prism 22A, which is parallel to the lateral direction Yb and extends in the vertical direction Yc. The top surface 22d is disposed to face the opening 11 in the first metal layer 110.

### Fourth Embodiment

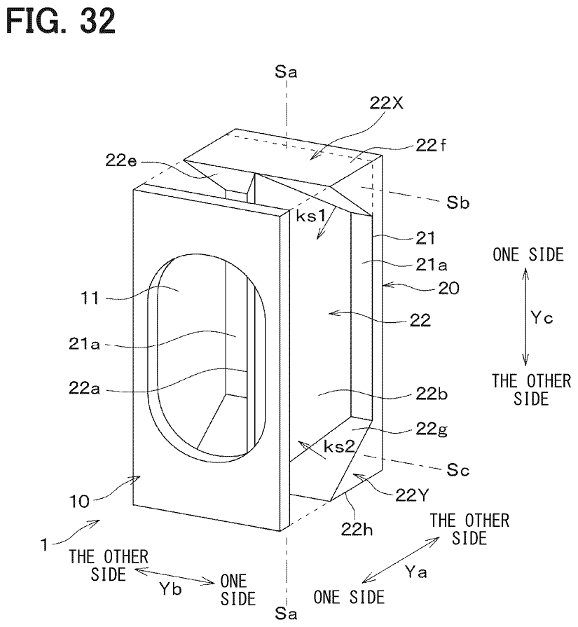

The fourth embodiment will be described with reference to FIGS. 32, 33, and 34, in which radio waves are retroreflected by using triangular prisms 22X, 22Y arranged in the vertical direction Yc in addition to the triangular prism 22. FIG. 32 is a perspective view showing the triangular prisms 22, 22X, 22Y of the electromagnetic wave absorber 1 of this embodiment, and is an enlarged perspective view of the electromagnetic wave absorber 1 of this embodiment.

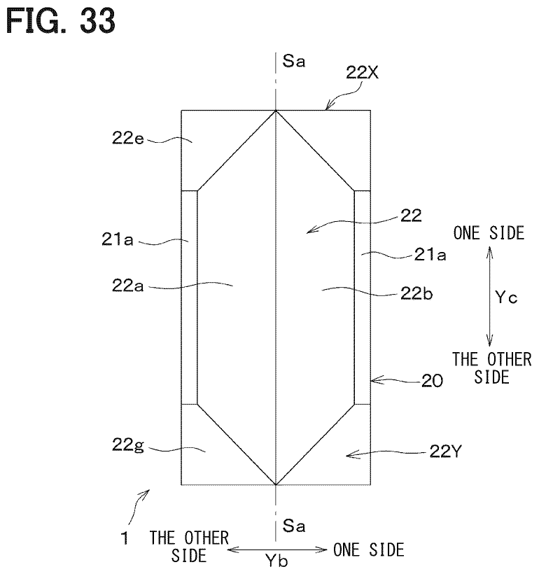

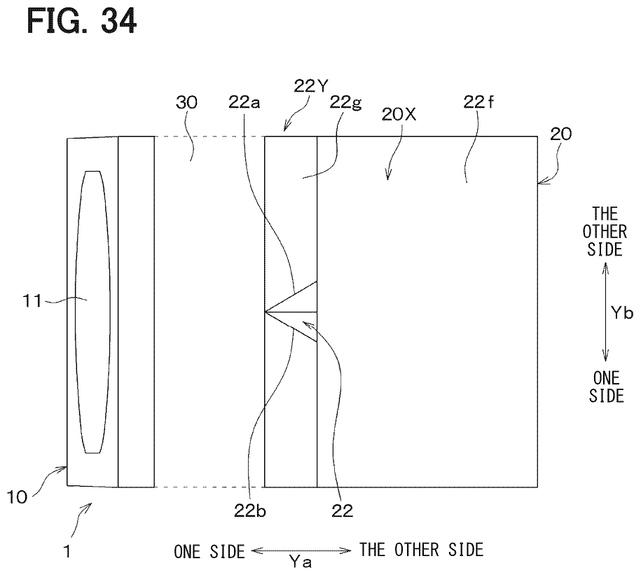

FIG. 33 is a front view of the triangular prisms 22, 22X, 22Y in the electromagnetic wave absorber 1 of this embodiment with the first metal layer 10 removed. FIG. 34 is a perspective view of the electromagnetic wave absorber 1 of this embodiment. In the second metal layer 20 of the electromagnetic wave absorber 1 of this embodiment, the triangular prisms 22X and 22Y are provided for each triangular prism 22, as shown in FIGS. 32, 33 and 34. The triangular prism 22X is a first reflector disposed for each triangular prism 22 on one side of the triangular prism 22 in the vertical direction Yc (i.e., the third direction).

The triangular prism 22X is a reflector formed in a triangular prism shape. The triangular prism 22X is formed so that its axis Sb extends in the lateral direction Yb. The triangular prism 22X is connected to one side of the triangular prism 22 in the vertical direction Yc. The triangular prism 22X is disposed on one side of the base layer 21 in the stacking direction Ya. The triangular prism 22X has an inclined surface 22e and an upper surface 22f. The inclined surface 22e is disposed on one side in the vertical direction Yc with respect to the inclined surface 22a, 22b. The vertical direction Yc is perpendicular to the stacking direction Ya and perpendicular to the lateral direction Yb, to connect the inclined surfaces 22a and 22b. The inclined surface 22e is a third inclined surface arranged such that its normal direction ks1 is inclined with respect to the stacking direction Ya.

The inclined surface 22e is formed to extend toward one side in the stacking direction Ya as extended toward one side in the vertical direction Yc. The inclined surface 22e is formed to extend toward the other side in the stacking direction Ya as extended toward the other side in the vertical direction Yc. The upper surface 22f is disposed on one side in the vertical direction Yc with respect to the inclined surface 22e. The upper surface 22f is formed parallel to the stacking direction Ya and parallel to the lateral direction Yb. The triangular prism 22Y is a second reflector disposed for each triangular prism 22 on the other side of the triangular prism 22 in the vertical direction Yc. The triangular prism 22Y is connected to the other side of the triangular prism 22 in the vertical direction Yc (i.e., the third direction).

The triangular prism 22Y is disposed on one side of the base layer 21 in the stacking direction Ya. The triangular prism 22Y has an inclined surface 22g and a lower surface 22h. The triangular prism 22Y is a reflector formed in a triangular prism shape. The triangular prism 22Y is formed so that its axis Sc extends in the lateral direction Yb. The inclined surface 22g is a fourth inclined surface arranged such that its normal direction ks2 is inclined with respect to the stacking direction Ya. The inclined surface 22g is disposed on the other side in the vertical direction Yc with respect to the inclined surface 22a, 22b. The inclined surface 22g is formed to extend toward one side in the stacking direction Ya as extended toward the other side in the vertical direction Yc.

The inclined surface 22g is formed to extend to the other side in the stacking direction Ya as extended to one side in the vertical direction Yc. The lower surface 22h is disposed on the other side in the vertical direction Yc with respect to the inclined surface 22g. The lower surface 22h is formed parallel to the stacking direction Ya and parallel to the lateral direction Yb. In this embodiment, the inclined surface 22e of the triangular prism 22X and the inclined surface 22g of the triangular prism 22Y face each other with the dielectric 30 interposed therebetween for each triangular prism 22. The inclined surface 22e, 22g, like the inclined surface 22a, 22b, retroreflects the incident electromagnetic wave D1 and the reflected electromagnetic wave D4.

Next, the operation of the electromagnetic wave absorber 1 of this embodiment will be described. In this embodiment, when one of the inclined surfaces 22e, 22g reflects the incident electromagnetic wave D1, the other of the inclined surfaces 22e, 22g reflects the incident electromagnetic wave D1 reflected by the one as a reflected electromagnetic wave D2. The other reflects the reflected electromagnetic wave D2 reflected by the one as a reflected electromagnetic wave D3 opposite to the incident electromagnetic wave D1, parallel to the traveling direction of the incident electromagnetic wave D1. That is, the other reflects the reflected electromagnetic wave D2 reflected by the one as a reflected electromagnetic wave D3 in the opposite direction to the incident electromagnetic wave D, along the traveling path of the incident electromagnetic wave D1. As a result, the inclined surface 22e, 22g retroreflects the incident electromagnetic wave D1.

When one of the inclined surfaces 22e, 22g reflects the reflected electromagnetic wave D4, the other of the inclined surfaces 22e, 22g reflects the reflected electromagnetic wave D4 reflected by the one as a reflected electromagnetic wave D5. The other reflects the reflected electromagnetic wave D5 reflected by the one as a reflected electromagnetic wave D6, opposite to the traveling direction of the reflected electromagnetic wave D4, parallel to the traveling path of the reflected electromagnetic wave D4. That is, the other reflects the reflected electromagnetic wave D5 reflected by the one as a reflected electromagnetic wave D6, opposite to the reflected electromagnetic wave D4, along the traveling path of the reflected electromagnetic wave D4. As a result, the inclined surface 22e, 22g retroreflects the reflected electromagnetic wave D4.

According to the present embodiment, the second metal layer 20 includes the inclined surface 22e located on one side in the vertical direction Yc with respect to the inclined surface 22a, 22b. The inclined surface 22e is formed such that the normal direction ks1 is inclined relative to the stacking direction Ya and extends toward one side in the stacking direction Ya as extended to one side in the vertical direction Yc. The second metal layer 20 includes the inclined surface 22g located on the other side in the vertical direction Yc with respect to the inclined surface 22a, 22b. The inclined surface 22g is formed such that the normal direction ks2 is inclined relative to the stacking direction Ya and extends toward one side in the stacking direction Ya as extended to the other side in the vertical direction Yc. As a result, the inclined surface 22e, 22g can appropriately retroreflect the incident electromagnetic wave D1 or the reflected electromagnetic wave D4.

In the present embodiment, the second metal layer 20 is located on one side in the vertical direction Yc with respect to the inclined surface 22a, 22b, and includes the triangular prism 22X formed into a triangular prism shape having the inclined surface 22e. The second metal layer 20 is located on the other side in the vertical direction Yc with respect to the inclined surface 22a, 22b, and includes the triangular prism 22Y formed in a triangular prism shape having the inclined surface 22g. In the second metal layer 20, the triangular prisms 22X and 22Y are provided for each of the triangular prisms 22. Therefore, it is possible to easily realize the inclined surface 22e, 22g to appropriately retroreflect the incident electromagnetic wave D1 or the reflected electromagnetic wave D4 for each triangular prism 22.

### Fifth Embodiment

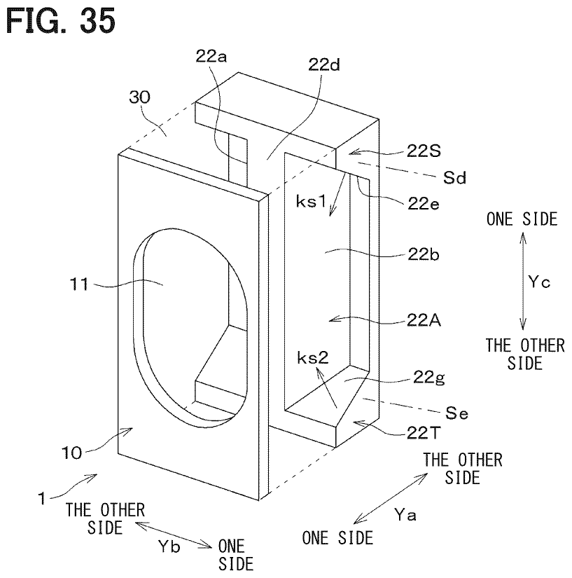

In the fourth embodiment, the triangular prisms 22X and 22Y are used in the electromagnetic wave absorber 1 to retroreflect the incident electromagnetic wave D1 or the reflected electromagnetic wave D4. Alternatively, in a fifth embodiment, an electromagnetic wave absorber 1 has rectangular prisms 22S, 22T to retroreflect the incident electromagnetic wave D1 or the reflected electromagnetic wave D4. The fifth embodiment will be described with reference to FIGS. 35, 36, 37, and 38.

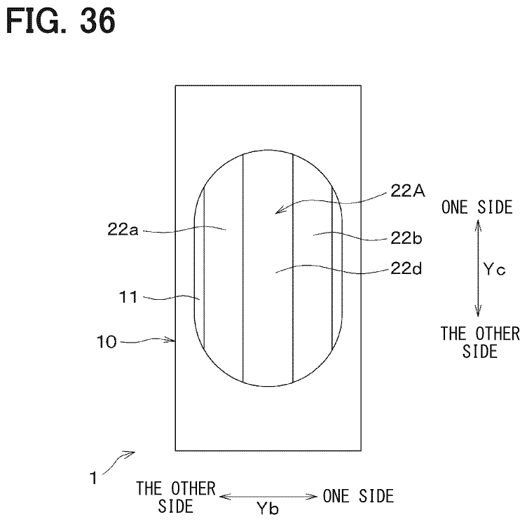

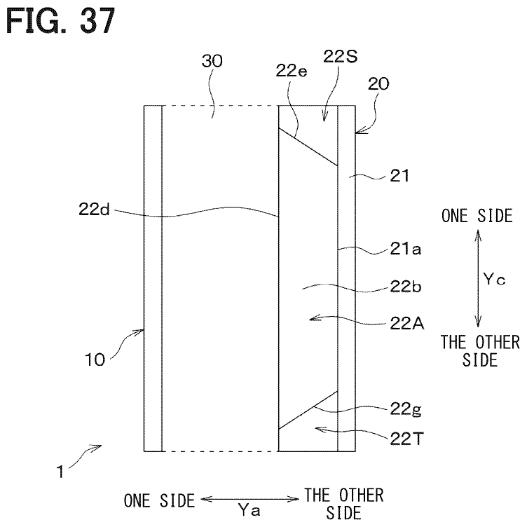

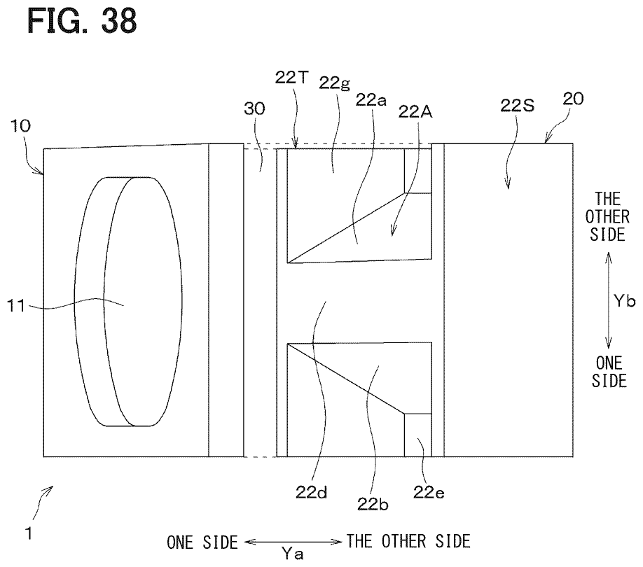

FIG. 35 is a perspective view showing a part of the electromagnetic wave absorber 1 of this embodiment. FIG. 36 is a front view showing a part of the electromagnetic wave absorber 1 of this embodiment. FIG. 37 is a side view showing a part of the electromagnetic wave absorber 1 of this embodiment. FIG. 38 is a perspective view showing a part of the electromagnetic wave absorber 1 of this embodiment. As shown in FIGS. 35, 36, 37 and 38, on the second metal layer 20 of the electromagnetic wave absorber 1 of this embodiment, the rectangular prisms 22S and 22T are provided for each rectangular prism 22A. The rectangular prism 22S is a first reflector disposed for each rectangular prism 22A on one side of the rectangular prism 22A in the vertical direction (i.e., the third direction) Yc.

The rectangular prism 22S is connected to one side of the rectangular prism 22A in the vertical direction Yc. The rectangular prism 22S is disposed on one side of the base layer 21 in the stacking direction Ya. The rectangular prism 22S is a reflector formed in a rectangular prism shape. The rectangular prism 22S is formed so that its axis Sd extends in the lateral direction Yb. The rectangular prism 22S has an inclined surface 22e. The inclined surface 22e is disposed so that its normal direction ks1 is inclined with respect to the stacking direction Ya. The inclined surface 22e is formed to extend to one side in the stacking direction Ya as extended to one side in the vertical direction Yc. The inclined surface 22e is formed to extend to the other side in the stacking direction Ya as extended to the other side in the vertical direction Yc.

The rectangular prism 22T is a second reflector disposed for each rectangular prism 22A on the other side of the rectangular prism 22A in the vertical direction (i.e., the third direction) Yc. The rectangular prism 22T is connected to the other side of the rectangular prism 22A in the vertical direction Yc. The rectangular prism 22T is disposed on one side of the base layer 21 in the stacking direction Ya. The rectangular prism 22T is a reflector formed in a rectangular prism shape. The rectangular prism 22T is formed so that its axis Se extends in the lateral direction Yb. The rectangular prism 22T has an inclined surface 22g. The inclined surface 22g is disposed so that its normal direction ks2 is inclined with respect to the stacking direction Ya. The inclined surface 22g is formed to extend to one side in the stacking direction Ya as extended to the other side in the vertical direction Yc. The inclined surface 22g is formed to extend to the other side in the stacking direction Ya as extended to the one side in the vertical direction Yc.

In this embodiment, the inclined surface 22e of the rectangular prism 22S and the inclined surface 22g of the rectangular prism 22T face each other with the dielectric 30 interposed therebetween for each rectangular prism 22A. The inclined surface 22e, 22g, like the inclined surface 22a, 22b, retroreflects the incident electromagnetic wave D1 and the reflected electromagnetic wave D4. Next, the operation of the electromagnetic wave absorber 1 of this embodiment will be described. In this embodiment, when one of the inclined surfaces 22e, 22g reflects the incident electromagnetic wave D1, the other of the inclined surfaces 22e, 22g reflects the incident electromagnetic wave D1 reflected by the one as a reflected electromagnetic wave D2.

The other reflects the reflected electromagnetic wave D2 reflected by the one as a reflected electromagnetic wave D3, opposite to the incident electromagnetic wave D1, parallel to the traveling path of the incident electromagnetic wave D1. That is, the other reflects the reflected electromagnetic wave D2 reflected by the one as a reflected electromagnetic wave D3, opposite to the incident electromagnetic wave D1, along the traveling path of the incident electromagnetic wave D1. As a result, the inclined surface 22e, 22g retroreflects the incident electromagnetic wave D1.

When one of the inclined surfaces 22e, 22g reflects the reflected electromagnetic wave D4, the other of the inclined surfaces 22e, 22g reflects the reflected electromagnetic wave D4 reflected by the one as a reflected electromagnetic wave D5. The other reflects the reflected electromagnetic wave D5 reflected by the one as a reflected electromagnetic wave D6, parallel to the traveling path of the reflected electromagnetic wave D4, in an opposite direction opposite to the traveling direction of the reflected electromagnetic wave D4. That is, the other reflects the reflected electromagnetic wave D5 reflected by the one as a reflected electromagnetic wave D6 along the traveling path of the reflected electromagnetic wave D4 in the opposite direction to the reflected electromagnetic wave D4. As a result, the inclined surface 22e, 22g retroreflects the reflected electromagnetic wave D4.

According to the present embodiment, the second metal layer 20 has the inclined surface 22e arranged on one side of the vertical direction Yc with respect to the inclined surface 22a, 22b, and whose normal direction is inclined relative to the stacking direction to extend toward one side in the stacking direction Ya as extending to one side in the vertical direction Yc. The second metal layer 20 is arranged on the other side of the vertical direction Yc with respect to the inclined surface 22a, 22b, and has the inclined surface 22g whose normal direction is inclined relative to the stacking direction to extend toward one side in the stacking direction Ya as extending to the other side in the vertical direction Yc. As a result, the inclined surface 22e, 22g can appropriately retroreflect the incident electromagnetic wave D1 or the reflected electromagnetic wave D4.

In the present embodiment, the second metal layer 20 is disposed on one side in the vertical direction Yc with respect to the inclined surface 22a, 22b, and includes the rectangular prism 22S formed in a rectangular prism shape having the inclined surface 22e. The second metal layer 20 is disposed on the other side in the vertical direction Yc with respect to the inclined surface 22a, 22b, and includes the rectangular prism 22T formed in a rectangular prism shape having the inclined surface 22g. In the second metal layer 20, the rectangular prisms 22S and 22T are provided for each triangular prism 22. Therefore, it is possible to easily realize the inclined surface 22e, 22g to appropriately retroreflect the incident electromagnetic wave D1 or the reflected electromagnetic wave D4 by the rectangular prism 22S, 22T.

### Sixth Embodiment

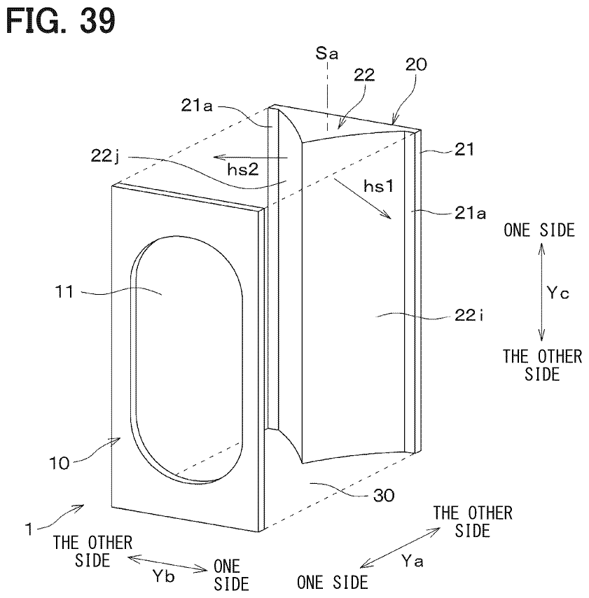

In the first embodiment, the second reflecting surface of the second metal layer 20 of the electromagnetic wave absorber 1 is formed by the inclined surface 22a, 22b of the triangular prism 22. Alternatively, in the sixth embodiment, the inclined surface 22i, 22j of the triangular prism 22 in the second metal layer 20 of the electromagnetic wave absorber 1 is formed by a curved surface as shown in FIGS. 39, 40, 41 and 42.

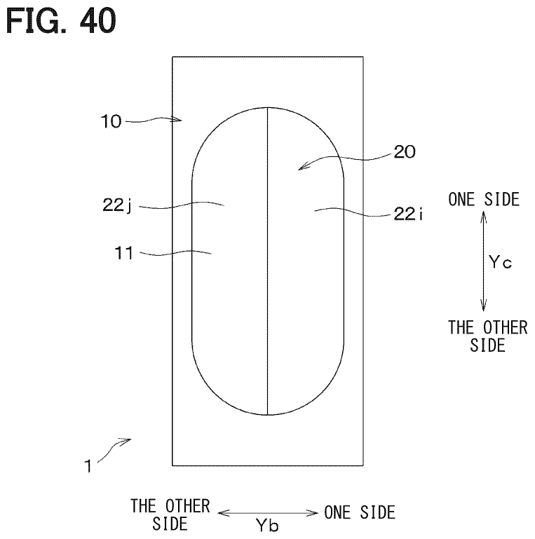

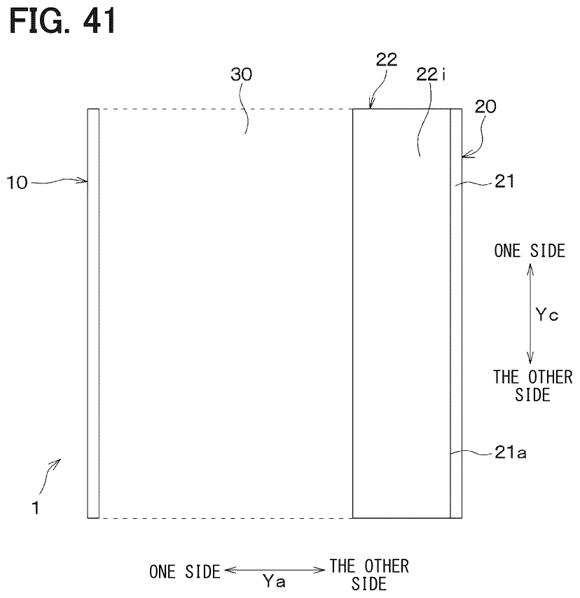

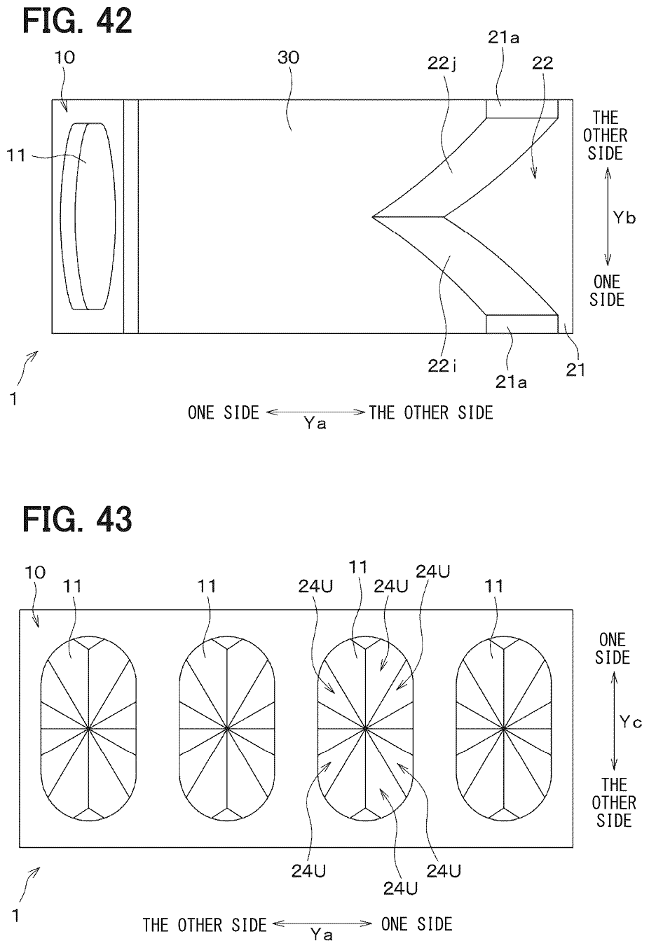

FIG. 39 is a perspective view showing the inclined surface 22i, 22j of the triangular prism 22 of the electromagnetic wave absorber 1 of this embodiment. FIG. 40 is a front view showing the inclined surface 22i, 22j of the triangular prism 22 of the electromagnetic wave absorber 1 of this embodiment. FIG. 41 is a side view showing the inclined surface 22i, 22j of the triangular prism 22 of the electromagnetic wave absorber 1 of this embodiment. FIG. 42 is a perspective view showing the inclined surface 22i, 22j of the triangular prism 22 of the electromagnetic wave absorber 1 of this embodiment. The triangular prism 22 of this embodiment is formed to have an axis Sa extended in the vertical direction Yc, similar to the triangular prism 22 of the first embodiment. The inclined surface 22i is formed in a curved shape recessed toward the other side in the stacking direction Ya. The inclined surface 22i is disposed on one side in the lateral direction Yb with respect to the inclined surface 22j.

The inclined surface 22i is a first inclined surface formed to extend to the other side in the stacking direction Ya as extended to the one side in the lateral direction Yb. The inclined surface 22i is inclined toward the one side in the stacking direction Ya as extended toward the other side in the lateral direction Yb. The inclined surface 22j is a first inclined surface formed in a curved shape recessed toward the other side in the stacking direction Ya. The inclined surface 22j is disposed on the other side in the lateral direction Yb with respect to the inclined surface 22i. The inclined surface 22j is formed to extend to the other side in the stacking direction Ya as extended to the other side in the lateral direction Yb. The inclined surface 22j is formed to extend to one side in the stacking direction Ya as extended to one side in the lateral direction Yb. The inclined surface 22i, 22j reflects the incident electromagnetic wave D1 and the reflected electromagnetic wave D4, similar to the inclined surface 22a, 22b of the first embodiment.

### Seventh Embodiment

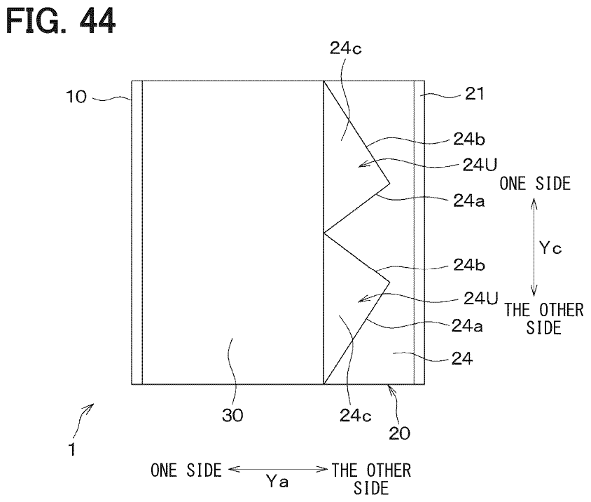

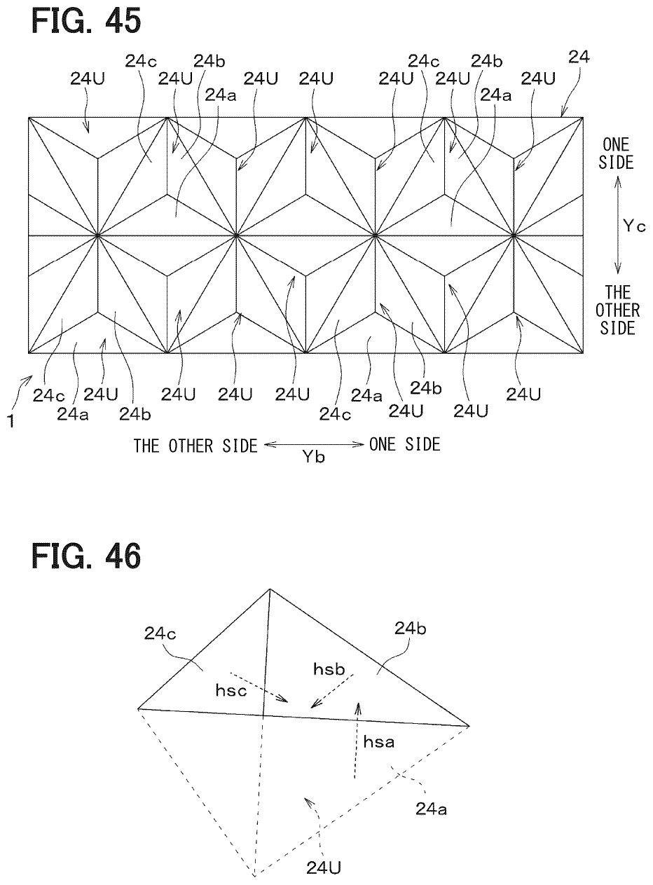

In the first embodiment, the second metal layer 20 of the electromagnetic wave absorber 1 retroreflects light at the two inclined surfaces 22a, 22b. Alternatively, in a seventh embodiment, retroreflection occurs at three inclined surfaces 24a, 24b, 24c in the second metal layer 20 of the electromagnetic wave absorber 1, as shown in FIGS. 43, 44, 45, and 46. FIG. 43 is a front view of the electromagnetic wave absorber 1 of this embodiment, and FIG. 44 is a side view of the electromagnetic wave absorber 1 of this embodiment. FIG. 45 is a front view of the second metal layer 20 alone in which the first metal layer 10 and the dielectric 30 are removed from the electromagnetic wave absorber 1 of FIG. 37. FIG. 46 is a perspective view showing the positional relationship between the three inclined surfaces 24a, 24b, 24c.

The electromagnetic wave absorber 1 of this embodiment differs from the electromagnetic wave absorber 1 of the first embodiment in the second metal layer 20. The second metal layer 20 of the electromagnetic wave absorber 1 of this embodiment will be described below. The second metal layer 20 is provided with a reflective layer 24 in place of the triangular prisms 22. The reflective layer 24 is disposed on one side of the base layer 21 in the stacking direction Ya. The reflective layer 24 is formed in a film extending in the lateral direction Yb and the vertical direction Yc with the stacking direction Ya being the thickness direction. The reflective layer 24 is made of a conductive metal material such as copper or silver.

In this embodiment, plural recesses 24U are provided on one side of the reflective layer 24 in the stacking direction Ya. Each of the recesses 24U is formed to open to one side in the stacking direction Ya and be recessed to the other side in the stacking direction Ya. In FIG. 46, the recess 24U is open obliquely upward. Each of the recesses 24U has a triangular pyramid-shaped recess formed by the inclined surfaces 24a, 24b, 24c. The inclined surface 24a is a reflecting surface whose normal direction hsa is inclined relative to the stacking direction Ya. The inclined surface 24b is a reflecting surface whose normal direction hsb is inclined relative to the stacking direction Ya. The inclined surface 24c is a reflecting surface whose normal direction hsc is inclined relative to the stacking direction Ya. The inclined surfaces 24a, 24b, 24c are three reflecting surfaces having a first reflecting surface, a second reflecting surface, and a third reflecting surface.

Next, the operation of the electromagnetic wave absorber 1 of this embodiment will be described. First, of the inclined surfaces 24a, 24b, 24c, for example, the first inclined surface reflects the incident electromagnetic wave D1. Then, the second inclined surface other than the first inclined surface reflects the incident electromagnetic wave D1 reflected by the first inclined surface as a reflected electromagnetic wave D2. In this case, among the inclined surfaces 24a, 24b, 24c, the third inclined surface other than the first inclined surface and the second inclined surface reflects the reflected electromagnetic wave D2 reflected by the second inclined surface as a reflected electromagnetic wave D3, which is parallel to the incident electromagnetic wave D1, in the opposite direction to the incident electromagnetic wave D1. That is, the third inclined surface reflects the reflected electromagnetic wave D2 reflected by the second inclined surface as a reflected electromagnetic wave D3 in an opposite direction of the incident electromagnetic wave D1. As a result, the incident electromagnetic wave D1 is retroreflected by the inclined surfaces 24a, 24b, 24c.

Furthermore, of the inclined surfaces 24a, 24b, 24c, for example, the first inclined surface reflects the reflected electromagnetic wave D4. Then, of the inclined surfaces 24a, 24b, 24c, a second inclined surface other than the first inclined surface reflects the reflected electromagnetic wave D4 reflected by the first inclined surface as a reflected electromagnetic wave D5. In this case, among the inclined surfaces 24a, 24b, 24c, the third inclined surface other than the first inclined surface and the second inclined surface reflects the reflected electromagnetic wave D5 reflected by the second inclined surface as a reflected electromagnetic wave D6, which is parallel to the reflected electromagnetic wave D4, in the opposite direction to the reflected electromagnetic wave D4. That is, the third inclined surface reflects the reflected electromagnetic wave D5 reflected by the second inclined surface as a reflected electromagnetic wave D6 in an opposite direction and along the reflected electromagnetic wave D4. As a result, the reflected electromagnetic wave D4 is retroreflected by the inclined surfaces 24a, 24b, 24c.

According to the present embodiment, the reflective layer 24 of the second metal layer 20 has the inclined surfaces 24a, 24b, 24c to form the recess 24U recessed in a triangular pyramid shape from one side to the other side in the stacking direction Ya. The inclined surfaces 24a, 24b, 24c can appropriately retroreflect the incident electromagnetic wave D1 and the reflected electromagnetic wave D4.

### Other Embodiment

(1) In the first embodiment, the electromagnetic wave absorber 1 retroreflects waves by the two inclined surfaces 22a, 22b. Furthermore, in the seventh embodiment, the electromagnetic wave absorber 1 retroreflects waves by the three inclined surfaces 24a, 24b, 24c. Alternatively, in the first to seventh embodiments, the electromagnetic wave absorber 1 may be configured to retroreflect waves by four or more inclined surfaces.
(2) In the second embodiment, each of the openings 11 is arranged to face two adjacent triangular prisms 22. However, instead of this, each of the openings 11 may be arranged to face three or more adjacent triangular prisms 22. Here, the number of openings 11 is an integer multiple of the number of triangular prisms 22.
(3) In the second embodiment, the triangular prism 22 formed in a triangular prism shape is used as the reflector of the present disclosure. However, the present disclosure is not limited to this, and the rectangular prism 22A of the third embodiment may be used as the multiple reflectors of the present disclosure. The rectangular prism 22A is a reflector formed in a rectangular prism shape, and the multiple rectangular prisms 22A are arranged in the lateral direction Yb. In this case, each of the openings 11 is disposed to face two or more adjacent rectangular prisms 22A. Here, the number of openings 11 is an integer multiple of the number of rectangular prisms 22A.
(4) In the first to seventh embodiments, the first metal layer 10 having the plural openings 11 is used as the first member of the present disclosure. However, instead of this, a semi-reflective member arranged on one side of the dielectric 30 in the stacking direction Ya may be used as the first member of the present disclosure. In this case, when an electromagnetic wave is incident on the semi-reflective member from one side in the stacking direction Ya, a part of the incident electromagnetic wave is transmitted through the semi-reflective member.

The electromagnetic waves are transmitted through the dielectric 30 and then retroreflected by the inclined surface 22a, 22b. This retroreflected electromagnetic wave passes through the dielectric 30 and then enters the semi-reflective member. A part of the incident electromagnetic wave is reflected by the semi-reflective member and emitted from the semi-reflective member to the other side in the stacking direction Ya. In this manner, the electromagnetic waves are multiple-reflected between the semi-reflective member and the inclined surface 22a, 22b.
(5) In the first to seventh embodiments, the first metal layer 10 having the plural openings 11 is used as the first member of the present disclosure. However, instead of this, plural metal patches arranged on one side of the dielectric 30 in the stacking direction Ya may be used as the first member of the present disclosure. The metal patches are, for example, formed in a plate shape from a conductive metal material. The multiple metal patches function as antennas that absorb electromagnetic waves arriving from one side in the stacking direction Ya and re-radiate the electromagnetic waves to the other side in the stacking direction Ya.

As a result, in the multiple metal patches, part of the electromagnetic waves arriving from one side in the stacking direction Ya passes through the multiple electrodes. On the other hand, when electromagnetic waves that have passed through the dielectric 30 are incident on the metal patches, the metal patches absorb the incident electromagnetic waves and re-radiate the electromagnetic waves to the other side in the stacking direction Ya. As a result, the metal patches reflect a part of the electromagnetic waves arriving from the other side in the stacking direction Ya. As the first member of the present disclosure, plural conductive loops may be used instead of the metal patches. The conductive loops may be circular or rectangular loops.
(6) In the sixth embodiment, the inclined surface 22i, 22j is a curved surface. In addition to this, in the second embodiment, the inclined surface 22a, 22b may be a curved surface. Similarly, in the third embodiment, the inclined surface 22a, 22b of the rectangular prism 22A may be a curved surface. In the fourth embodiment, the inclined surface 22e of the triangular prism 22X and the inclined surface 22g of the triangular prism 22Y may be a curved surface. In the fifth embodiment, the inclined surface 22e of the rectangular prism 22S and the inclined surface 22g of the rectangular prism 22T may be a curved surface.
(7) In the fourth embodiment, the triangular prism 22X is used as the first reflector disposed on one side of the inclined surface 22a, 22b in the vertical direction Yc. The triangular prism 22Y is used as the second reflector disposed on the other side in the vertical direction Yc with respect to the inclined surface 22a, 22b. However, instead of this, at least one of the first reflector and the second reflector may be a rectangular prism formed in a rectangular prism shape.
(8) In the fifth embodiment, the rectangular prism 22S is used as the first reflector disposed on one side of the inclined surface 22a, 22b in the vertical direction Yc. The rectangular prism 22T is used as the second reflector disposed on the other side in the vertical direction Yc with respect to the inclined surface 22a, 22b. However, instead of this, at least one of the first reflector and the second reflector may be a triangular prism formed in a triangular prism shape.
(9) The present disclosure is not limited to the above-described embodiments and may be suitably modified. In addition, the embodiments are not unrelated to each other, and may be appropriately combined unless the combination is obviously impossible. Further, in each of the embodiments, it goes without saying that components of the embodiment are not necessarily essential except for a case in which the components are particularly clearly specified as essential components, a case in which the components are clearly considered in principle as essential components, and the like. Further, in each of the embodiments, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the embodiments, when referring to the shape, positional relationship, and the like of the components and the like, the shape and relationship are not limited to the shape, positional relationship, and the like, except for the case where the shape and the positional relationship are specifically specified, the case where the shape and the positional relationship are fundamentally limited to a specific shape, positional relationship, and the like.

What is claimed is:

1. An electromagnetic wave absorber comprising:
a first member configured to transmit an electromagnetic wave incident from one side in a predetermined direction;
a dielectric disposed on the other side of the first member in the predetermined direction; and
a second member disposed on the other side of the dielectric in the predetermined direction, wherein
the second member has a plurality of inclined surfaces configured to retroreflect the electromagnetic wave transmitted through the dielectric,
a normal direction of the plurality of inclined surfaces is inclined with respect to the predetermined direction, and
the dielectric is configured to attenuate the electromagnetic wave transmitted through the first member in a state where the electromagnetic wave is multi-reflected to resonate between the plurality of inclined surfaces and the first member.

2. The electromagnetic wave absorber according to claim 1, wherein
an incident electromagnetic wave, which is the electromagnetic wave that has passed through the first member and the dielectric, is retroreflected by the plurality of inclined surfaces,
a first reflected electromagnetic wave, which is the incident electromagnetic wave retroreflected by the plurality of inclined surfaces, passes through the dielectric,
a second reflected electromagnetic wave, which is the first reflected electromagnetic wave transmitted through the dielectric, is reflected by the first member, and
the electromagnetic wave resonates when a wavefront of the second reflected electromagnetic wave reflected by the first member coincides with a wavefront of the incident electromagnetic wave transmitted through the dielectric.

3. The electromagnetic wave absorber according to claim 1, wherein
the predetermined direction is defined as a first direction and a direction perpendicular to the first direction is defined as a second direction,
the plurality of inclined surfaces includes:
a first inclined surface extended to one side in the first direction as extending to one side in the second direction; and
a second inclined surface located on the other side of the first inclined surface in the second direction and extended to the one side in the first direction as extending to the other side in the second direction, and
when one of the first inclined surface and the second inclined surface reflects the electromagnetic wave that has passed through the dielectric, the other of the first inclined surface and the second inclined surface reflects the electromagnetic wave reflected by the one to retroreflect the electromagnetic wave that has passed through the dielectric, in an opposite direction along a traveling path of the electromagnetic wave that has passed through the dielectric.

4. The electromagnetic wave absorber according to claim 3, wherein
the first inclined surface is one of a plurality of first inclined surfaces,
the second inclined surface is one of a plurality of second inclined surfaces, and
the first inclined surface and the second inclined surface are arranged alternately in the second direction.

5. The electromagnetic wave absorber according to claim 4, wherein
the second member has a plurality of reflectors each having the first inclined surface and the second inclined surface located on the other side of the first inclined surface in the second direction to form a rectangular prism shape, and
the plurality of reflectors is arranged in the second direction such that the first inclined surface and the second inclined surface are arranged alternately in the second direction.

6. The electromagnetic wave absorber according to claim 5, wherein
the first member has a plurality of openings to transmit the electromagnetic wave incident from the one side in the predetermined direction, and
the plurality of reflectors is disposed to face the plurality of openings respectively.

7. The electromagnetic wave absorber according to claim 5, wherein
the first member has a plurality of openings to transmit the electromagnetic waves incident from the one side in the predetermined direction,
one of the plurality of reflectors is arranged to face at least two of the openings, and
the number of the openings is an integer multiple of the number of the reflectors.

8. The electromagnetic wave absorber according to claim 5, wherein the reflector is formed in a triangular prism shape having the first inclined surface and the second inclined surface.

9. The electromagnetic wave absorber according to claim 5, wherein the reflector is formed in a rectangular prism shape having the first inclined surface and the second inclined surface.

10. The electromagnetic wave absorber according to claim 3, wherein
a third direction is defined as perpendicular to the first direction and perpendicular to the second direction,
the plurality of inclined surfaces further includes:
a third inclined surface located on the one side of the first inclined surface and the second inclined surface in the third direction to have a normal direction inclined to the first direction and extended to the one side in the first direction as extending to one side in the third direction; and
a fourth inclined surface located on the other side of the first inclined surface and the second inclined surface in the third direction to have a normal direction inclined to the first direction and extended to the one side in the first direction as extending to the other side in the third direction, and
when one of the third inclined surface and the fourth inclined surface reflects the electromagnetic wave that has passed through the dielectric, the other of the third inclined surface and the fourth inclined surface reflects the electromagnetic wave reflected by the one, to retroreflect the electromagnetic wave that has passed through the dielectric, in an opposite direction along a traveling path of the electromagnetic wave that has passed through the dielectric.

11. The electromagnetic wave absorber according to claim 10, wherein
the second member includes:
a first reflector located on the one side of the first inclined surface and the second inclined surface in the third direction and formed in a prism shape having the third inclined surface; and
a second reflector located on the other side of the first inclined surface and the second inclined surface in the third direction and formed in a prism shape having the fourth inclined surface.

12. The electromagnetic wave absorber according to claim 11, wherein at least one of the first reflector and the second reflector is formed in a triangular prism shape.

13. The electromagnetic wave absorber according to claim 11, wherein at least one of the first reflector and the second reflector is formed in a rectangular prism shape.

14. The electromagnetic wave absorber according to claim 3, wherein
each of the first inclined surface and the second inclined surface has a dimension in the first direction, and
the dimension is set within a range between 0.15·λ and 0.55·λ, where λ is a wavelength of the electromagnetic wave traveling within the dielectric.

15. The electromagnetic wave absorber according to claim 1, wherein
the second member has three reflecting surfaces to form a triangular pyramidal recess recessed from the one side to the other side in the predetermined direction, and
when a first reflecting surface of the three reflecting surfaces reflects the electromagnetic wave that has passed through the dielectric, and a second reflecting surface of the three reflecting surfaces reflects the electromagnetic wave reflected by the first reflecting surface, a third reflecting surface of the three reflecting surfaces reflects the electromagnetic wave reflected by the second reflecting surface to retroreflect the electromagnetic wave that has passed through the dielectric, in an opposite direction along a traveling path of the electromagnetic wave that has passed through the dielectric.

16. The electromagnetic wave absorber according to claim 1, wherein each of the plurality of inclined surfaces is a curved surface.
